(19) United States
(12) Patent Application Publication
(10) Pub. No.: US 2024/0404778 A1
(43) Pub. Date: Dec. 5, 2024

(54) PROTECTIVE ELEMENT

(71) Applicant: DEXERIALS CORPORATION, Shimotsuke-shi, Tochigi (JP)

(72) Inventor: Yoshihiro YONEDA, Shimotsuke-shi, Tochigi (JP)

(73) Assignee: DEXERIALS CORPORATION, Shimotsuke-shi, Tochigi (JP)

(21) Appl. No.: 18/688,017

(22) PCT Filed: Aug. 30, 2022
(86) PCT No.: PCT/JP2022/032553

§ 371 Date: Feb. 29, 2024

(30) Foreign Application Priority Data
Sep. 3, 2021 (JP) 2021-144287
Jul. 29, 2022 (JP) 2022-121949

(51) Int. Cl. H01H 85/38; H01H 85/175

(52) U.S. Cl. CPC H01H 85/38; H01H 85/175

(57) ABSTRACT

A protective element includes: a fuse element including a first end portion and a second end portion; an insulating member having an opening or a separation part, the insulating member being disposed in a state proximal to or in contact with the fuse element; a shielding member movable in an insertion direction to be inserted into the opening or the separation part of the insulating member so as to divide the fuse element; a pressing member that press the shielding member; a locking member that is fixed between the insulting case and the shielding member, optionally using a fixing member, and suppresses movement of the shielding member; and a heat-generating body configured to heat the locking member or the fixing member.

### TECHNICAL FIELD

The present invention relates to a protective element.

The present application claims priority to JP 2021-144287 filed in Japan on Sep. 3, 2021 and JP 2022-121949 filed in Japan on Jul. 29, 2022. The contents of these applications are hereby incorporated.

### BACKGROUND ART

Conventionally, there are fuse elements wherein heat is generated and fusion occurs when a current exceeding a rated value flows in a current path, thereby cutting off the current path. A protective element provided with a fuse element (fuse element) is used in a wide variety of fields such as home electric appliances and electric automobiles.

Lithium ion batteries, for example, are used in a wide variety of applications such as mobile devices, electric vehicles (EVs), and storage batteries, and capacity is increasing. As the capacity of lithium ion batteries increases, high voltage specifications have reached several hundred volts, and high current specifications of several hundred amperes to several thousand amperes are also required.

For example, Patent Literature 1 teaches a fuse element provided with two elements connected between terminal portions positioned at both end portions and a fusion portion provided in a substantially central portion of the elements as a fuse element used mainly in electric circuits for an automobile or the like. Patent Literature 1 teaches a fuse wherein two fuse elements are stored in a casing and an arc extinguishing material is sealed between the fuse elements and the casing.

### PRIOR ART LITERATURE

### Patent Literature

Patent Literature 1: JP 2017-004634 A

### SUMMARY OF THE INVENTION

### Problem to be Solved by the Invention

In a protective element installed in a current path having high voltage and high current, arc discharge is likely to occur when a fuse element fuses. When large-scale arc discharge occurs, the insulating case having the fuse element housed therein may breakdown. Therefore, the generation of arc discharge is suppressed using a low resistance and high melting point metal such as copper as a material of the fuse element. Furthermore, a strong and highly heat-resistant material such as ceramic is used as a material of the insulating case, and the size of the insulating case is further increased.

Furthermore, up until now, the only current fuses having high voltage and high current (100 V/100 A or greater) have had overcurrent cutoff, and there has been no way to also achieve a cutoff function using a cutoff signal.

In light of the above, an object of the present invention is to provide a protective element wherein large-scale arc discharge does not readily occur when a fuse element fuses, the size of an insulating case can be made smaller and lighter, and both overcurrent cutoff in response to a high voltage/high current and a cutoff function via a cutoff signal are accomplished.

### Means for Solving the Problem

The present invention provides the following means for solving the problem described above.

### Aspect 1 of the Present Invention

A protective element including a fuse element, an insulating case that houses the fuse element, a first terminal, and a second terminal, and further including: an insulating member arranged in a state proximal to or in contact with the fuse element and in which an opening or a separation part is formed; a shielding member which can be moved in an insertion direction to be inserted into the opening or the separation part of the insulating member so as to divide the fuse element; pressing means that press the shielding member in an insertion direction of the shielding member; a locking member that is locked between the insulting case and the shielding member and suppresses movement of the shielding member; a heat-generating body that heats and softens the locking member or a fixing member fixing the locking member; and a power supply member that carries current to the heat-generating body, wherein the fuse element includes a first end portion and a second end portion that mutually oppose, the first terminal has one end portion connected to the first end portion and the other end portion exposed from the insulating case to the outside, the second terminal has one end portion connected to the second end portion and the other end portion exposed from the insulating case to the outside, and the insulating case further houses the insulating member, the shielding member, the pressing means, the locking member, the heat-generating body, and a portion of the power supply member.

### (Aspect 2 of the Present Invention)

The protective element according to aspect 1, wherein the heat-generating body generates heat and the locking member or the fixing member softens, by which pressing force of the pressing means causes the shielding member to move while separating the locking member or the fixing member, and furthermore, the shielding member moves through the opening or the separation part of the insulating member to cut the fuse element, thereby cutting off energization of the fuse element.

### (Aspect 3 of the Present Invention)

The protective element according to aspect 2, wherein the shielding member cuts the fuse element, shielding each portion of the cut fuse element in the current carrying direction of the fuse element.

### (Aspect 4 of the Present Invention)

The protective element according to any one of aspects 1 to 3, wherein the pressing means is a spring.

### (Aspect 5 of the Present Invention)

The protective element according to any one of aspects 1 to 4, wherein at least one among the insulating member, the shielding member, and the insulating case is formed of a material having a comparative tracking index CTI of 500 V or more.

### (Aspect 6 of the Present Invention)

The protective element according to any one of aspects 1 to 5, wherein at least one among the insulating member, the shielding member, and the insulating case is formed of a resinous material of a type selected from a group consisting of polyamide-based resins and fluorine-based resin.

### (Aspect 7 of the Present Invention)

The protective element according to any one of aspects 1 to 6, wherein the fuse element is a stacked body containing a low melting point metal layer and high melting point metal layer, the low melting point metal layer containing tin, and the high melting point metal layer containing silver or copper.

### (Aspect 8 of the Present Invention)

The protective element according to aspect 7, wherein the fuse element includes two or more layers of the high melting point metal layer and one or more layer of the low melting point metal layer, and is a stacked body having the low melting point metal layers arranged between the high melting point metal layers.

### (Aspect 9 of the Present Invention)

The protective element according to any one of aspects 1 to 8, wherein the fuse element is a single layer containing silver or copper.

### (Aspect 10 of the Present Invention)

The protective element according to any one of aspects 1 to 9, wherein the fuse element has a fusion portion between the first end portion and the second end portion, and the cross-sectional area of the fusion portion in the current carrying direction is less than the cross-sectional area of the first end portion and the second end portion in the current carrying direction from the first end portion to the second end portion.

### (Aspect 11 of the Present Invention)

The protective element according to any one of aspects 1 to 10, wherein the fuse element has a first fusible conductor and a second fusible conductor having a lower melting point than the first fusible conductor, the first fusible conductor and the second fusible conductor being connected in series in energization.

### (Aspect 12 of the Present Invention)

The protective element according to aspect 11, wherein the second fusible conductor is arranged between two first fusible conductors.

### (Aspect 13 of the Present Invention)

The protective element according to aspect 11 or 12, wherein the shielding member moves and the second fusible conductor is cut due to heat generation of the heat-generating body.

### (Aspect 14 of the Present Invention)

The protective element according to any one of aspects 1 to 13, wherein the insulating case has an inner bottom surface arranged in a state proximal to or in contact with the opposite side of the shielding member of the fuse element, the inner bottom surface having a groove extending along the opening or the separation part of the insulating member, and a leading edge of the shielding member in the insertion direction is insertable into the groove.

### (Aspect 15 of the Present Invention)

The protective element according to any one of aspects 1 to 14, further having a plurality of the fuse element laminated in parallel in a perpendicular direction relative to a surface of a plate-shaped fuse element, and a plurality of the insulating member arranged in contact or proximally between the plurality of fuse elements, wherein each of the openings or the separation parts of the plurality of insulating members overlap each other when viewed from the perpendicular direction, and the shielding member is movable within all of the openings or the separation parts.

### (Aspect 16 of the Present Invention)

The protective element according to aspect 15, wherein the plurality of insulating members includes the insulating member arranged on the outer side of the outermost layer on the shielding member side of the plurality of fuse elements, the insulating case has an inner bottom surface arranged in a state proximal to or in contact with the outer side of the outermost layer on the opposite side of the shielding member of the plurality of fuse elements, the inner bottom surface having a groove extending along the opening or the separation part of the insulating member, and the shielding member is movable within in all of the openings or the separation parts and the groove.

### (Aspect 17 of the Present Invention)

The protective element according to any one of aspects 1 to 16, further having a plurality of the fuse elements laminated in parallel in a perpendicular direction relative to a surface of the plate-shaped fuse element, and the plurality of insulating members arranged in contact or proximally between and on the outer side of the plurality of fuse elements, wherein each of the openings or the separation parts of the plurality of insulating members overlap each other when viewed from the perpendicular direction, and the shielding member is movable within all of the openings or the separation parts.

### (Aspect 18 of the Present Invention)

The protective element according to any one of aspects 1 to 17, wherein the insulating case has at least two holding members arranged on both sides of the fuse element in a perpendicular direction relative to a surface of the plate-shaped fuse element, one or both of the two holding members being formed integrally with the insulating member.

### (Aspect 19 of the Present Invention)

The protective element according to any one of aspects 1 to 18, wherein the locking member is locked by being interposed between the insulating case and the shielding member in the insertion direction of the shielding member, and the dimension of the locking member in the insertion direction is larger than the dimension of the locking member in the direction from the heat-generating body to the locking member when viewed from the width direction orthogonal to the current carrying direction of the fuse element and the insertion direction of the shielding member or when viewed from the current carrying direction.

### (Aspect 20 of the Present Invention)

The protective element according to any one of aspects 1 to 19, wherein the shielding member has a first step part facing the insertion direction of the shielding member, the insulating case has a second step part facing the opposite side of the first step part in the insertion direction, and a pair of end surfaces of the locking member facing the insertion direction is interposed between the first step part and the second step part, and when viewed from the insertion direction, do not mutually overlap the first step part and the second step part.

### Effect of the Invention

According to the present invention, it is possible to provide a protective element wherein large-scale arc discharge does not readily occur when a fuse element fuses, the size of an insulating case can be made smaller and lighter, and both overcurrent cutoff in response to a high voltage/high current and a cutoff function via a cutoff signal are accomplished.

### BRIEF DESCRIPTION OF THE DRAWINGS

FIG. 1 is a perspective view of a protective element according to a first reference example that differs from the present invention in a portion of the technical concept.

FIG. 2 is a partial perspective view for viewing the interior of the protective element illustrated in FIG. 1.

FIG. 3 is an exploded perspective view of the protective element illustrated in FIG. 1.

FIG. 4A is a plan view schematically illustrating a first terminal, a second terminal, and one fusible conductor sheet configuring a fuse element stacked body.

FIG. 4B is a plan view schematically illustrating the fuse element stacked body, a second insulating member, the first terminal, and the second terminal.

FIG. 4C is a cross-sectional view along the X-X′ line in the plan view illustrated in FIG. 4B.

FIG. 5 is a cross-sectional view along the V-V′ line in FIG. 1 and illustrates a vicinity of a locking member thereof as an enlarged view.

FIG. 6 is a cross-sectional view of a protective element in a state wherein a shielding member has cut the fuse element and is all the way down.

FIG. 7 is a cross-sectional view of a protective element having a modified example of the locking member, and illustrates the vicinity of the locking member thereof as an enlarged view.

FIG. 8A illustrates one example of a structure of a heat-generating body and represents an upper surface plan view.

FIG. 8B illustrates one example of a structure of the heat-generating body and represents an upper surface plan view of an insulating substrate before printing.

FIG. 8C illustrates one example of a structure of the heat-generating body and represents an upper surface plan view after resistance layer printing.

FIG. 8D illustrates one example of a structure of the heat-generating body and represents an upper surface plan view after insulating layer printing.

FIG. 8E illustrates one example of a structure of the heat-generating body and represents an upper surface plan view after electrode layer printing.

FIG. 8F illustrates one example of a structure of the heat-generating body and represents a lower surface plan view.

FIG. 9A is a perspective view of the protective element for describing a method for extracting a power supply member that supplies power to the heat-generating body, and illustrates a case in which two heat-generating bodies are connected in series.

FIG. 9B is a perspective view of the protective element for describing a method for extracting a power supply member that supplies power to the heat-generating body, and illustrates a case in which two heat-generating bodies are connected in parallel.

FIG. 10A is a schematic diagram of a modified example of the first reference example, and illustrates a perspective view of a holding member 10BB that is a modified example of a holding member 10B.

FIG. 10B is a schematic diagram of a modified example of the first reference example, and illustrates a perspective view of the holding member 10BB that is a modified example of the holding member 10B, and a first insulating member 61A and a second insulating member 61B that are modified examples of a first insulating member 60A and a second insulating member 60B.

FIG. 11A is a perspective view of the second insulating member 61B of the modified example.

FIG. 11B is a perspective view of the first insulating member 61A of the modified example.

FIG. 12A is a partial perspective view schematically illustrated for viewing the interior of the protective element according to a second reference example.

FIG. 12B is a lower side perspective view of the shielding member of FIG. 12A.

FIG. 13 is a cross-sectional view of the protective element according to the second reference example, corresponding to FIG. 5.

FIG. 14 is a cross-sectional view of the protective element in a state wherein the shielding member has divided the fuse element and is all the way down.

FIG. 15 is a perspective view schematically illustrating a state wherein the fuse element stacked body, the first terminal, and the second terminal are installed on a first holding member.

FIG. 16 is a cross-sectional view (a cross-sectional view perpendicular to the width direction) illustrating a protective element according to an embodiment.

FIG. 17 is a cross-sectional view (a cross-sectional view perpendicular to the width direction) illustrating the protective element according to the embodiment, and represents a state in which the shielding member has divided the fuse element and is all the way down.

FIG. 18 is a cross-sectional view (a cross-sectional view perpendicular to the width direction) partially schematically illustrating the protective element according to the embodiment.

FIG. 19 is a cross-sectional view (a cross-sectional view perpendicular to the width direction) partially schematically illustrating the protective element according to the embodiment, and represents a state in which the shielding member has moved downward.

FIG. 20 is a cross-sectional view (a cross-sectional view perpendicular to the width direction) partially schematically illustrating the protective element according to a modified example of the embodiment.

FIG. 21 is a cross-sectional view (a cross-sectional view perpendicular to the width direction) partially schematically illustrating the protective element according to a modified example of the embodiment, and represents a state in which the shielding member has moved downward.

FIG. 22 is a cross-sectional view (X—Z cross-sectional view) partially illustrating the protective element according to a modified example of the embodiment.

FIG. 23 is a schematic diagram of the fuse element according to a modified example of the embodiment, and is a plan view corresponding to FIG. 4A.

### MODES FOR CARRYING OUT INVENTION

A detailed description will be given hereinafter with appropriate reference to drawings for a reference example that differs in part from the present invention in technical concept. In the drawings used in the description below, characteristic portions may be enlarged for convenience to more easily understand the characteristics thereof, and the dimensional ratios of each constituent element and the like may be different from the actual ratios. The materials, dimensions, and the like exemplified in the following description are mere examples, and the present invention is not limited thereby. The present invention can be implemented by making appropriate modifications as long as the effect of the present invention is demonstrated.

### (Protective Element (First Reference Example))

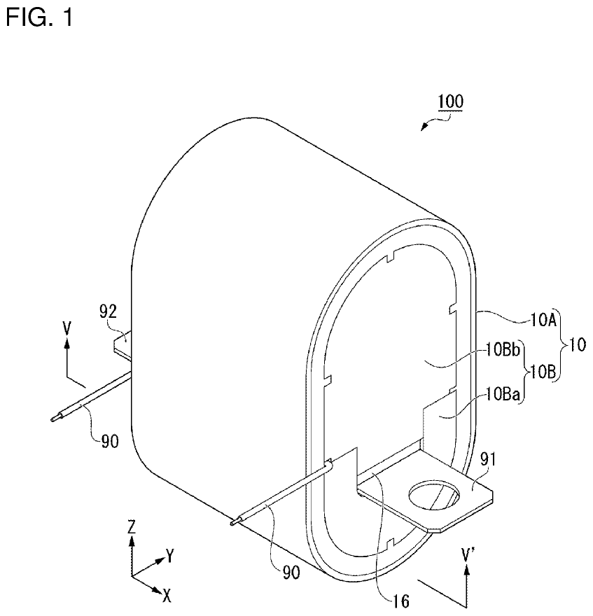

FIGS. 1 to 5 are schematic diagrams illustrating a protective element according to a first reference example. In the drawings used in the description below, the direction indicated by X is the current carrying direction of the fuse element. The direction indicated by Y is a direction orthogonal to the X direction, and is also referred to as the width direction. In the present reference example, one side in the width direction (Y direction) corresponds to the −Y side, and the other side corresponds to the +Y side. However, this is not limited thereto, and one side in the width direction may correspond to the +Y side, and the other side in the width direction may correspond to the −Y side. The direction indicated by Z is a direction orthogonal to the X direction and the Y direction, and is also referred to as the thickness direction. The thickness direction may be referred to in other words as the vertical direction. In the vertical direction (Z direction), upward corresponds to the +Z side, and downward corresponds to the −Z side.

Note that in the present reference example, upward and downward are simply names for describing the relative positional relationship of each part, and the actual arrangement relationship may be an arrangement relationship other than the arrangement relationship indicated by these names.

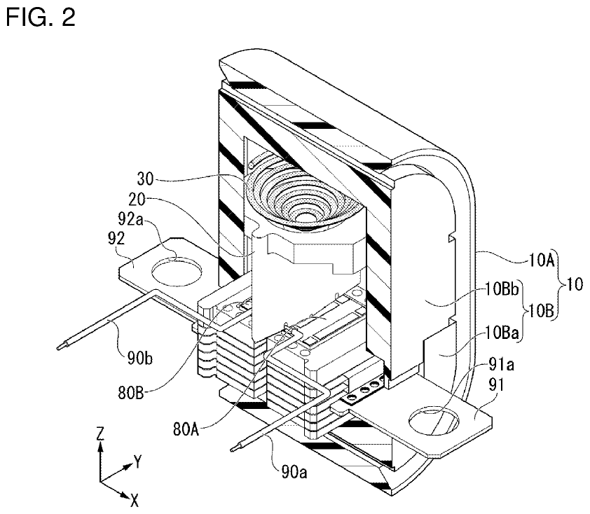

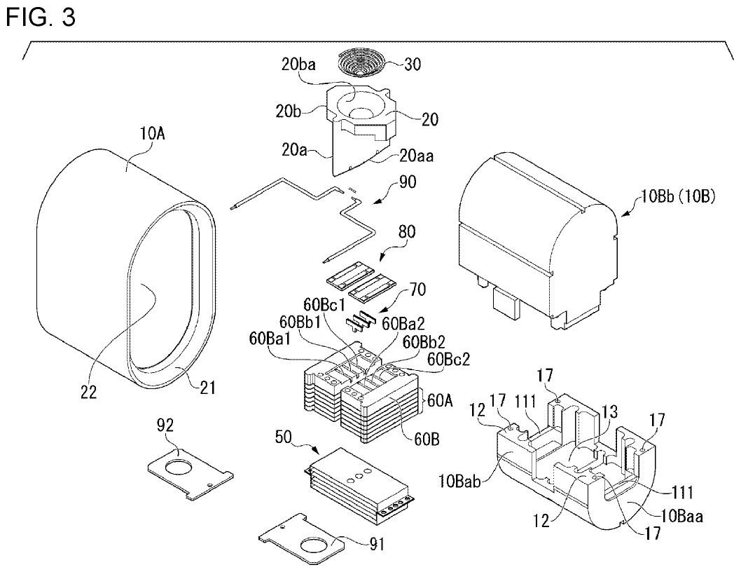

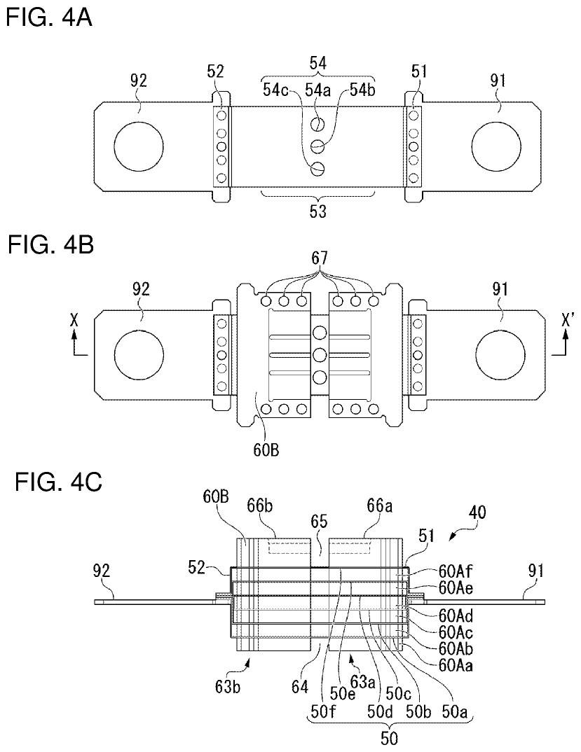

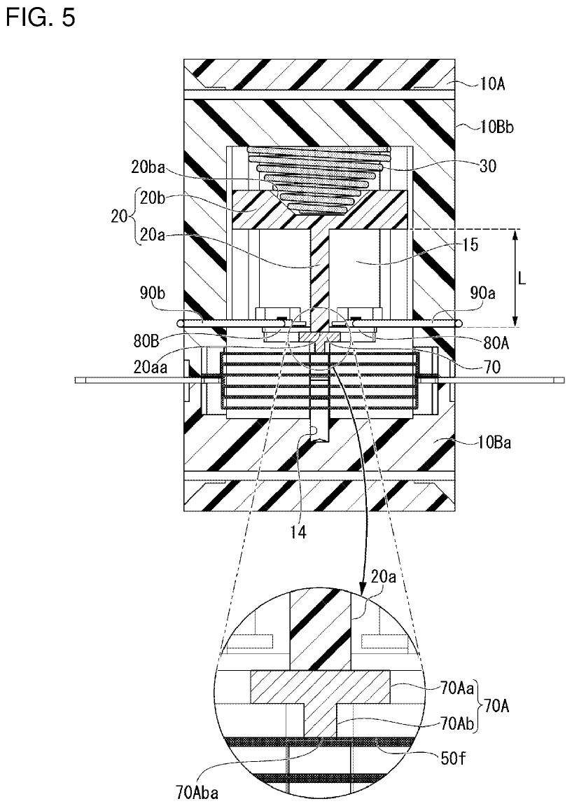

FIG. 1 is a perspective diagram schematically illustrating a protective element according to a first reference example. FIG. 2 is a partial perspective view schematically illustrated for viewing the interior of the protective element illustrated in FIG. 1. FIG. 3 is an exploded perspective view schematically illustrating the protective element illustrated in FIG. 1. FIG. 4A is a plan view schematically illustrating a first terminal, a second terminal, and one fusible conductor sheet configuring a fuse element stacked body. FIG. 4B is a plan view schematically illustrating the fuse element stacked body, a second insulating member, the first terminal, and the second terminal. FIG. 4C is a cross-sectional view along the X-X′ line in the plan view illustrated in FIG. 4B. FIG. 5 is a cross-sectional view along the V-V′ line in FIG. 1 and illustrates the vicinity of a locking member thereof as a magnified view.

The protective element 100 illustrated in FIG. 1 to FIG. 5 has an insulating case 10, a fuse element stacked body 40, a first insulating member 60A, a second insulating member 60B, a shielding member 20, pressing means 30, a locking member 70, a heat-generating body 80, power supply members 90a and 90b, a first terminal 91, and a second terminal 92. Note that the first insulating member 60A and the second insulating member 60B may be simply referred to in other words as insulating members 60A and 60B.

In the protective element 100 of the present reference example, the current carrying direction means the direction in which electricity flows during use (X direction), in other words, corresponding to the direction connecting the first terminal 91 and the second terminal 92. Note that, in the current carrying direction, the direction from the first terminal 91 to the second terminal 92 may be called the second terminal 92 side (−X side) and the direction from the second terminal 92 to the first terminal 91 may be called the first terminal 91 side (+X side). Moreover, the cross-sectional area in the current carrying direction means the area of a surface (Y—Z surface) in a direction orthogonal to the current carrying direction.

In the protective element 100 illustrated in FIG. 1 to FIG. 5, an example is illustrated wherein the first insulating member 60A and the second insulating member 60B are members having different configurations, but the first insulating member 60A and second insulating member 60B may be members having the same configuration.

The protective element 100 of the present reference example has overcurrent cutoff and active cutoff as mechanisms for cutting off the current path. In overcurrent cutoff, when an overcurrent that exceeds the rated current flows through the fusible conductor sheet 50 (see FIG. 4C), the fusible conductor sheet 50 is fused to cut off the current path. In active cutoff, when an abnormality other than overcurrent occurs, a current is carried to the heat-generating body 80 to melt the locking member 70 suppressing movement of the shielding member 20, and the shielding member 20 to which a pressing force is applied downward by the pressing means 30 is moved to cut the fuse element 50 and cut off the current path.

### (Insulating Case)

The insulating case 10 is a substantial elongated cylindrical shape (a cross section of the Y—Z surface is an ellipse at any position in the X direction). The insulating case 10 is made up of a cover 10A and a holding member 10B.

The cover 10A has an elongated cylindrical shape having both ends opened. The inside edges of the openings of the cover 10A are chamfered inclined surfaces 21. A central portion of the cover 10A is a housing portion 22 for housing the holding member 10B.

The holding member 10B is made up of a first holding member 10Ba arranged on the lower side in the Z direction and a second holding member 10Bb arranged on the upper side in the Z direction.

As illustrated in FIG. 3, a terminal mounting surface 111 is provided on both end portions (first end portion 10Baa and second end portion 10Bab) of the first holding member 10Ba in the current carrying direction (X direction).

Furthermore, as illustrated in FIG. 3, a power supply member mounting surface 12 is provided on both end portions (the first end portion 10Baa and the second end portion 10Bab) of the first holding member 10Ba. The routing distance of the power supply member 90 is shortened by the position (height) in the Z direction of the power supply member mounting surface 12 being substantially the same height as the position (height) of the heat-generating body 80.

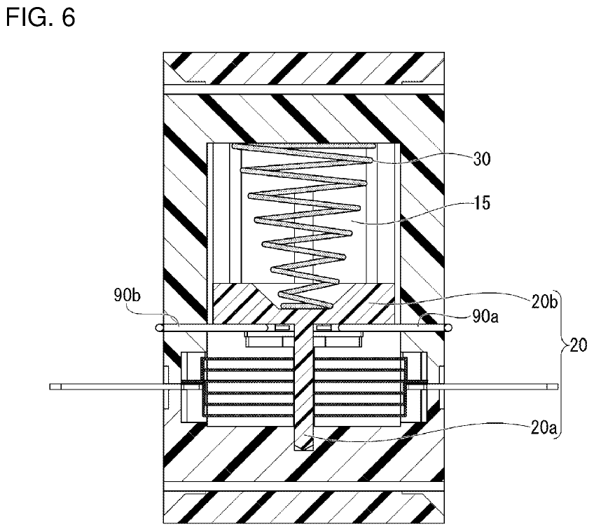

An internal pressure buffer space 15 (see FIG. 5 and FIG. 6) is formed inside the holding member 10B. The internal pressure buffer space 15 acts to suppress rapid rises in internal pressure in the protective element 100 by gas generated by arc discharge caused when the fuse element stacked body 40 is fused.

The cover 10A and the holding member 10B are preferably formed of a material having a tracking resistance index CTI (resistance to tracking (carbonized conduction path) breakdown) of 500 V or greater.

The tracking resistance index CTI can be found by testing based on IEC60112.

A resin material can be used as the material for the cover 10A and the holding member 10B.

Resin materials have a lower heat capacity and a lower melting point than ceramic materials. Therefore, it is preferable to use a resin material as the material of the holding member 10B, due to the characteristic wherein an arc discharge is weakened due to gasification cooling (ablation), and the characteristic wherein metal particles are sparse and a conductive path is difficult to form due to the surface deformation of the holding member 10B and adherents being coagulated when melted and scattered metal particles adhere to the holding member 10B.

For example, a polyamide-based resin or a fluorine-based resin can be used as the resin material. The polyamide-based resin may be an aliphatic polyamide or a semi-aromatic polyamide. Examples of an aliphatic polyamide include nylon 4, nylon 6, nylon 46, and nylon 66. Examples of a semi-aromatic polyamide include nylon 6T, nylon 9T, and polyphthalamide (PPA) resin. An example of a fluorine-based resin is polytetrafluoroethylene. Furthermore, polyamide-based resins and fluorine-based resins have high heat resistance and are difficult to burn. In particular, aliphatic polyamides do not easily generate graphite even when burned. Therefore, forming the cover 10A and the holding member 10B using an aliphatic polyamide makes it possible to reliably prevent a new current path from being formed by graphite generated during arc discharge when the fuse element stacked body 40 fuses.

### (Fuse Element Stacked Body)

The fuse element stacked body has a plurality of fusible conductor sheets arranged in parallel in the thickness direction, and a plurality of the first insulating member, which is arranged between each of the plurality of fusible conductor sheets and on an outer side of the fusible conductor sheet arranged on the lowermost of the plurality of fusible conductor sheets in a state proximal to or in contact with the fusible conductor sheets, and in which a first opening or a first separation part is formed. Note that the plurality of fusible conductor sheets are collectively referred to as a fuse element. The fuse element stacked body is made up of the fuse element and the first insulating member.

The fuse element stacked body 40 has six fusible conductor sheets 50a, 50b, 50c, 50d, 50e, and 50f arranged in parallel in the thickness direction (Z direction). First insulating members 60Ab, 60Ac, 60Ad, 60Ae, and 60Af are arranged between each of the fusible conductor sheets 50a to 50f. The first insulating members 60Aa to 60Af are arranged in a state proximal to or in contact with each of the fusible conductor sheets 50a to 50f. When arranged in proximity, the distance between the first insulating members 60Ab to 60Af and the fusible conductor sheets 50a to 50f is preferably 0.5 mm or less, and more preferably 0.2 mm or less.

Moreover, the first insulating member 60Aa is arranged on an outer side of the fusible conductor sheet 50a arranged on the lowermost of the fusible conductor sheets 50a to 50f. Additionally, the second insulating member 60B is arranged on an outer side of the fusible conductor sheet 50f arranged on the uppermost of the fusible conductor sheets 50a to 50f. The width (length in the Y direction) of the fusible conductor sheets 50a to 50f is narrower than the width of the first insulating members 60Aa to 60Af and the second insulating member 60B.

The fuse element stacked body 40 is an example wherein there are six fusible conductor sheets, but the present invention is not limited to six, and it is sufficient as long as there are a plurality.

Each of the fusible conductor sheets 50a to 50f has a first end portion 51 and a second end portion 52 that face each other, and a fusion portion 53 positioned between the first end portion 51 and the second end portion 52. The first end portion 51 of the three fusible conductor sheets 50a to 50c from the bottom among the fusible conductor sheets 50a to 50f arranged in parallel in the thickness direction are connected to the lower surface of the first terminal 91, and the first end portion 51 of the three fusible conductor sheets 50d to 50f from the top are connected to the upper surface of the first terminal 91. Moreover, the second end portion 52 of the three fusible conductor sheets 50a to 50c from the bottom among the fusible conductor sheets 50a to 50f are connected to the lower surface of the second terminal 92, and the second end portion 52 of the three fusible conductor sheets 50d to 50f from the top are connected to the upper surface of the second terminal 92. Note that the connecting positions of the fusible conductor sheets 50a to 50f and the first terminal 91 and the second terminal 92 are not limited to this. For example, all of the first end portions 51 of the fusible conductor sheets 50a to 50f may be connected to the upper surface of the first terminal 91 or may be connected to the lower surface of the first terminal 91. Moreover, all of the second end portions 52 of the fusible conductor sheets 50a to 50f may be connected to the upper surface of the second terminal 92, and may be connected to the lower surface of the second terminal 92.

Each of the fusible conductor sheets 50a to 50f may be a stacked body containing a low melting point metal layer and a high melting point metal layer, and may be a single layer. A stacked body containing a low melting point metal layer and a high melting point metal layer may have a structure wherein the periphery of the low melting point metal layer is covered by a high melting point metal layer.

The low melting point metal layer of the stacked body contains Sn. The low melting point metal layer may be an Sn simple substance or an Sn alloy. An Sn alloy is an alloy having Sn as a principal component. An Sn alloy is an alloy wherein the content of Sn is highest among the metals contained in the alloy. Examples of an Sn alloy include Sn—Bi alloys, In—Sn alloys, and Sn—Ag—Cu alloys. The high melting point metal layer contains Ag or Cu. The high melting point metal layer may be an Ag simple substance, a Cu simple substance, an Ag alloy, or a Cu alloy. An Ag alloy is an alloy wherein the content of Ag is highest among the metals contained in the alloy, and a Cu alloy is an alloy wherein the content of Cu is highest among the metals contained in the alloy. A stacked body may have a two-layer structure of a low melting point metal layer/high melting point metal layer, and may have a multilayer structure of three or more layers containing two or more layers of a high melting point metal layer and one or more layers of a low melting point metal layer, wherein the low melting point metal layer is arranged between the high melting point metal layers.

In the case of a single layer, the layer contains Ag or Cu. A single layer may be solely Ag, may be solely Cu, may be an Ag alloy, and may be a Cu alloy.

Each of the fusible conductor sheets 50a to 50f may include a through-hole 54 (54a, 54b, 54c) in the fusion portion 53. In the examples illustrated in the figures, there are three through-holes, however, the number is not limited. Having the through-hole 54 makes the cross-sectional area of the fusion portion 53 smaller than the cross-sectional area of the first end portion 51 and the second end portion 52. In the case that a large current that exceeds a rated value flows to each of the fusible conductor sheets 50a to 50f, by having the cross-sectional area of the fusion portion 53 be smaller, the amount of heat generated in the fusion portion 53 increases, by which the fusion portion 53 forms a fusion portion and readily fuses. The configuration by which the fusion portion 53 fuses more readily than the first end portion 51 and second end portion 52 sides is not limited to a through-hole, and configurations that narrow a width and partially thin a thickness are also possible. A notch shape such as a perforation is also acceptable.

Moreover, in each of the fusible conductor sheets 50a to 50f, the fusion portion 53, which is configured to readily be fused, is readily cut by a protruding portion 20a of the shielding member 20.

The thickness of the fusible conductor sheets 50a to 50f is a thickness that is fused by an overcurrent and that is physically cut by the shielding member 20. The specific thickness depends on the material or number (number of sheets) of the fusible conductor sheets 50a to 50f and a pressing force (stress) of the pressing means 30, however, for example, in the case that the fusible conductor sheets 50a to 50f are a copper foil, a range can be set to 0.01 mm to 0.1 mm as a standard. Moreover, in the case that the fusible conductor sheets 50a to 50f are a foil having Ag plated on a periphery of an alloy whose principal component is Sn, a range can be set to 0.1 mm to 1.0 mm as a standard.

Each of the first insulating members 60Aa to 60Af are made up of a first insulating piece 63a and a second insulating piece 63b that face each other through a gap (first separation part) 64. The second insulating member 60B is similarly made up of a third insulating piece 66a and a fourth insulating piece 66b that face each other through a gap (second separation part) 65. In the examples illustrated in the figures, the gaps 64 and 65 of the first insulating members 60Aa to 60Af and the second insulating member 60B are separation parts (first separation part and second separation part) that separate into two members, but may be openings (first opening and second opening) that permit movement (passage) of the protruding portion 20a of the shielding member 20. The above two members are the first insulating piece 63a and the second insulating piece 63b, or the third insulating piece 66a and the fourth insulating piece 66b. Note that the first separation part 64 and the second separation part 65 may be simply referred to in other words as separation parts 64 and 65. Furthermore, the first opening and the second opening may be simply referred to in other words as openings (see first opening 64A and second opening 65A of a modified example described below).

The first insulating piece 63a and the second insulating piece 63b respectively have, on both end sides in the Y direction, a ventilation hole 67 for efficiently releasing an increase in pressure, which accompanies arc discharge generated during cutoff of the fuse element, to a pressing means housing space of the insulating case. In the examples illustrated in the figures, the first insulating piece 63a and the second insulating piece 63b respectively have three of the ventilation hole 67 on each of both end sides in the Y direction, however, the number is not limited.

The increase in pressure generated by arc discharge passes through the ventilation holes 67, and is efficiently released to the space housing the pressing means 30 of the insulating case 10 through gaps in four corners (not illustrated) provided between a pressing means support portion 20b and the second holding member 10Bb. Furthermore, as a result, shielding action of the shielding member 20 is carried out smoothly and breakdown of the first insulating members 60Aa to 60Af and the second insulating member 60B is prevented.

The gaps 64 and 65 are positioned facing the fusion portion 53 arranged between the first end portion 51 and the second end portion 52 of the fusible conductor sheets 50a to 50f. That is, the first insulating members 60Aa to 60Af and the second insulating member 60B are separated at positions facing the fusion portion 53 of the fusible conductor sheets 50a to 50f.

It is preferable that the first insulating members 60Aa to 60Af and the second insulating member 60B be formed of a material having a tracking resistance index CTI of 500 V or more.

A resin material can be used as the material for the first insulating members 60Aa to 60Af and the second insulating member 60B. Examples of the resin material are the same as the case for the cover 10A and the holding member 10B.

The fuse element stacked body 40 can be manufactured, for example, in the following manner.

Using a jig having positioning recesses corresponding to protrusions provided on the first insulating members 60Aa to 60Af and the second insulating member 60B and positioning-fixing portions for the first terminal 91 and the second terminal 92, the fusible conductor sheets 50a to 50f and the first insulating members 60Ab to 60Af are each alternately stacked on the first insulating member 60Aa in the thickness direction, and the second insulating member 60B is arranged on the upper surface of the fusible conductor sheet 50f, which is arranged uppermost, to obtain a stacked body.

### (Shielding Member)

The shielding member 20 has the protruding portion 20a, which faces the fuse element stacked body 40 side, and the pressing means support portion 20b, which has a recessed portion 20ba that houses and supports a lower portion of the pressing means 30.

Downward movement of the shielding member 20 is suppressed by the locking member 70 in a state wherein the pressing force of the pressing means 30 is applied downward. Therefore, when the locking member 70 is heated by heat generated by the heat-generating body 80 and softened at a temperature at or above a softening temperature thereof, the shielding member 20 becomes able to move downward. At this time, the softened locking member 70 is physically cut by the shielding member 20, or is thermally fused, or receives an action combining physical cutting from the shielding member 20 and thermal fusion depending on the material type, heating conditions, and the like.

When the downward movement suppression by the locking member 70 is released, the shielding member 20 moves downward and physically cuts the fusible conductor sheets 50a to 50f.

The shielding member 20 has a leading edge 20aa of the protruding portion 20a that is pointed, formed to readily cut through the fusible conductor sheets 50a to 50f.

FIG. 6 illustrates a cross-sectional view of the protective element in a state wherein the shielding member 20 has moved through the gaps 64 and 65 in the fuse element stacked body 40, cut through the fusible conductor sheets 50a, 50b, 50c, 50d, 50e, and 50f using the protruding portion 20a, and the shielding member 20 is all the way down.

The shielding member 20 lowers through the gaps 64 and 65 in the fuse element stacked body 40 and cuts through the fusible conductor sheets 50f, 50e, 50d, 50c, 50b, and 50a in order using the protruding portion 20a of the shielding member 20. As a result, the cut surfaces are shielded and insulated by the protruding portion 20a, and the current carrying path through each of the fusible conductor sheets is physically and reliably cut off. Thus, arc discharge is rapidly eliminated (extinguished).

Moreover, when the shielding member 20 moves through the gaps 65 and 64 of the fuse element stacked body 40 and is all the way down, the pressing means support portion 20b of the shielding member 20 presses the fuse element stacked body 40 from the second insulating member 60B, and the fusible conductor sheets and the first insulating members 60Aa to 60Af as well as the second insulating member 60B adhere to each other. Therefore, a space where arc discharge can continue therebetween is eliminated, and arc discharge is reliably eliminated.

The thickness (length in the X direction) of the protruding portion 20a is smaller than the width of the gaps 64 and 65 of the first insulating members 60Aa to 60Af and the second insulating member 60B in the X direction. According to this configuration, the protruding portion 20a can move in the gaps 64 and 65 downward in the Z direction.

For example, when the fusible conductor sheets 50a to 50f are a copper foil, the difference between the thickness of the protruding portion 20a and the width of the gaps 64 and 65 in the X direction can be set to 0.05 to 1.0 mm, for example, and is preferably set to 0.2 to 0.4 mm. When 0.05 mm or more, the movement of the protruding portion 20a becomes smooth when the cut minimum thickness is 0.01 mm even if the end portions of the fusible conductor sheets 50a to 50f enter the gap between the first insulating members 60Aa to 60Af and second insulating member 60B and the protruding portion 20a, and arc discharge is eliminated more quickly and reliably. This is because the protruding portion 20a does not easily catch when the difference described above is 0.05 mm or more. Moreover, when the difference is 1.0 mm or less, the gaps 64 and 65 function as guides that move the protruding portion 20a. Therefore, a positional shift of the protruding portion 20a while moving during fusion of the fusible conductor sheets 50a to 50f is prevented, and arc discharge is more quickly and reliably eliminated. When the fusible conductor sheets 50a to 50f are a foil having Ag plated on a periphery of an alloy whose principal component is Sn, the difference between the thickness of the protruding portion 20a and the width of the gaps 64 and 65 in the X direction can be set to 0.2 to 2.5 mm, for example, and is preferably set to 0.22 to 2.2 mm.

The width (length in the Y direction) of the protruding portion 20a is wider than the width of the fusible conductor sheets 50a to 50f of the fuse element stacked body 40. According to this configuration, the protruding portion 20a can cut each of the fusible conductor sheets 50a to 50f.

The length L of the protruding portion 20a in the Z direction has a length such that the leading edge 20aa of the protruding portion 20a can reach below the first insulating member 60Aa arranged lowermost of the first insulating members 60Aa to 60Af in the Z direction when the protruding portion is all the way down in the Z direction. When below the first insulating member 60Aa arranged lowermost, the protruding portion 20a is inserted into an insertion hole 14 formed on an inner bottom surface 13 of the holding member 10Ba.

According to this configuration, the protruding portion 20a can cut each of the fusible conductor sheets 50a to 50f.

### (Pressing Means)

The pressing means 30 is housed in the recessed portion 20ba of the shielding member 20 while the shielding member 20 is pressed downward in the Z direction.

For example, known means capable of imparting an elastic force such as a spring, rubber, and the like can be used as the pressing means 30.

A spring is used as the pressing means 30 in the protective element 100. The spring (pressing means) 30 is held in a compressed state in the recessed portion 20ba of the shielding member 20.

A known material can be used for the material of the spring used as the pressing means 30.

A cylindrical or conical spring can be used as the spring used as the pressing means 30. Contraction length can be shortened when using a conical spring, which allows for the suppression of a pressing height and miniaturization of the protective element. Moreover, conical springs can be stacked in a plurality to increase stress.

In the case of using a conical spring as the pressing means 30, the side having a smaller outer diameter may be arranged facing the fusion portion (cut portion) 53 side of each of the fusible conductor sheets 50a to 50f, and the side having a larger outer diameter may be arranged facing the fusion portion 53 side of each of the fusible conductor sheets 50a to 50f.

When using a conical spring as the pressing means 30, the side having a smaller outer diameter is arranged facing the fusion portion (cut portion) 53 side of each of the fusible conductor sheets 50a to 50f. Thus, for example, when the spring is formed of a conductive material such as a metal, continuation of arc discharge generated when cutting the fusion portion 53 of each of the fusible conductor sheets 50a to 50f can be more effectively suppressed. This is because a distance between the location of arc discharge generation and the conductive material forming the spring is easily secured.

Moreover, in the case of using a conical spring as the pressing means 30 wherein the side having the larger outer diameter is arranged facing the fusion portion 53 side of each of the fusible conductor sheets 50a to 50f, an elastic force can be uniformly imparted from the pressing means 30 by the shielding member 20, and is preferable.

### (Locking Member)

The locking member 70 bridges the gap 65 of the second insulating member 60B and suppresses movement of the shielding member 20.

The protective element 100 is provided with three locking members 70 (70A, 70B, 70C), but the present invention is not limited to three locking members.

The locking member 70A is mounted (inserted) in a groove 60Ba1 and a groove 60Ba2 of the second insulating member 60B, the locking member 70B is mounted (inserted) in a groove 60Bb1 and a groove 60Bb2 of the second insulating member 60B, and the locking member 70C is mounted (inserted) in a groove 60Bc1 and a groove 60Bc2 of the second insulating member 60B.

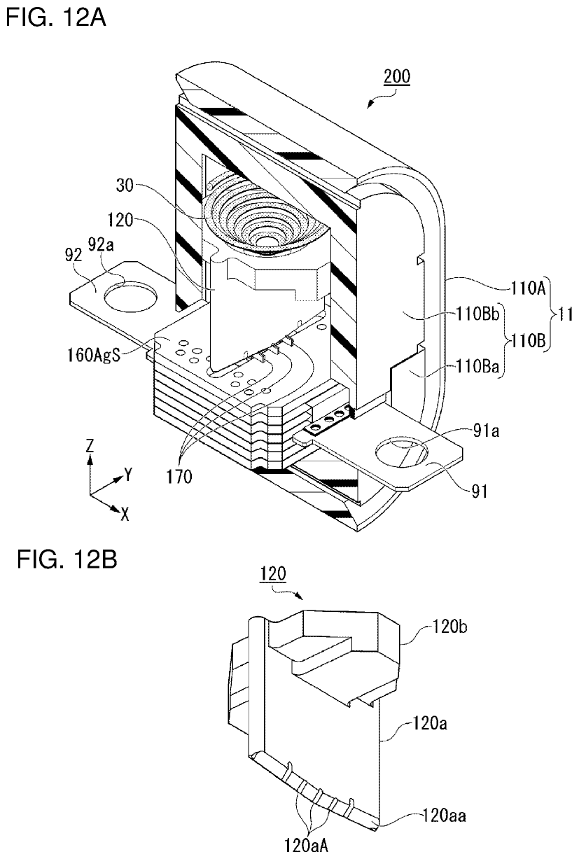

Moreover, there is a groove corresponding to the shape and position of the locking member 70 in the leading edge 20aa of the protruding portion 20a of the shielding member 20 (see FIG. 12B), and this groove stably holds so as to interpose the locking member 70.

The three locking members 70A, 70B, and 70C have the same shape. A description of the shape of the locking member 70A is given using the drawings. The locking member 70A has a support portion 70Aa mounted on and supported by a groove formed in the second insulating member 60B, and a projecting portion 70Ab that extends downward from the support portion and has a leading edge 70Aba that is proximal to or in contact with the uppermost fusible conductor sheet 50f. Among the locking members 70, all of the locking members 70 have the same shape, but different shapes may be included.

Heat-generating bodies 80A and 80B are mounted on the locking members 70A, 70B, and 70C. When a current is carried to the heat-generating bodies 80A and 80B, the heat-generating bodies 80A and 80B generate heat, transmit heat to the locking members 70, and the locking members 70 are heated and softened at a temperature at or above the softening temperature. Here, the softening temperature means a temperature or temperature range where a solid phase and a liquid phase mix or coexist. When the temperature of the locking members 70 is at or above the softening temperature, the locking members soften enough to deform due to external forces.

The softened locking members 70 are easily physically cut by the protruding portion 20a of the shielding member 20 pressed by the pressing force of the pressing means 30. When the locking members 70 are cut, the protruding portion 20a of the shielding member 20 is inserted downward in the Z direction into the gaps 65 and 64.

When the protruding portion 20a is inserted downward in the Z direction into the gaps 65 and 64, the protruding portion 20a protrudes on and reaches the lowest position while cutting the fusible conductor sheets. Thus, the protruding portion 20a shields the fusible conductor sheets 50a to 50f on the first terminal 91 side and the second terminal 92 side at the fusion portions 53 thereof. Thus, arc discharge generated when the fusible conductor sheets 50a to 50f are cut can be quickly and reliably eliminated.

The fusible conductor sheet 50f is heated via the locking members 70 by the heat generation of the heat-generating bodies 80A and 80B, and the other fusible conductor sheets are also heated, so that the fusible conductor sheets 50a to 50f are easily physically cut. Moreover, the fusible conductor sheet 50f can be thermally fused depending on the magnitude of heat generation of the heat-generating bodies 80A and 80B. In this case, the protruding portion 20a protrudes on as-is until reaching the lowest position.

In the locking members 70, the projecting portion 70Ab is in contact with the fusible conductor sheet 50f. Thus, when an overcurrent that exceeds the rated current flows through the fusible conductor sheet, the locking members 70 in contact with the fusible conductor sheet 50f transfer heat, the temperature thereof rises, and softening occurs at a temperature at or above the softening temperature.

Moreover, when a large overcurrent flows and the fusible conductor sheet 50f instantly fuses, generated arc discharge also flows to the locking members 70, and the locking members 70 soften at a temperature at or above the softening temperature.

The softened locking members 70 are easily physically cut by the protruding portion 20a of the shielding member 20 pressed by the pressing force of the pressing means 30. When the locking members 70 are cut, the protruding portion 20a of the shielding member 20 is inserted downward in the Z direction into the gaps 65 and 64.

In this case, an overcurrent that exceeds the rated current flows, the fusible conductor sheets are thermally fused, and the protruding portion 20a is inserted as-is downward in the Z direction into the gaps 65 and 64. At this time, the protruding portion 20a shields the fusible conductor sheets 50a to 50f on the first terminal 91 side and the second terminal 92 side at the fusion portions thereof. Thus, arc discharge generated when the fusible conductor sheets 50a to 50f are cut can be quickly and reliably eliminated.

Even if the fusible conductor sheets are not yet thermally fused, when the protruding portion 20a is inserted downward in the Z direction into the gaps 65 and 64, the protruding portion 20a protrudes on until reaching the lowest position while cutting the fusible conductor sheets. Thus, the protruding portion 20a shields the fusible conductor sheets 50a to 50f on the first terminal 91 side and the second terminal 92 side at the fusion portions thereof. Thus, arc discharge generated when the fusible conductor sheets 50a to 50f are cut off can be quickly and reliably eliminated.

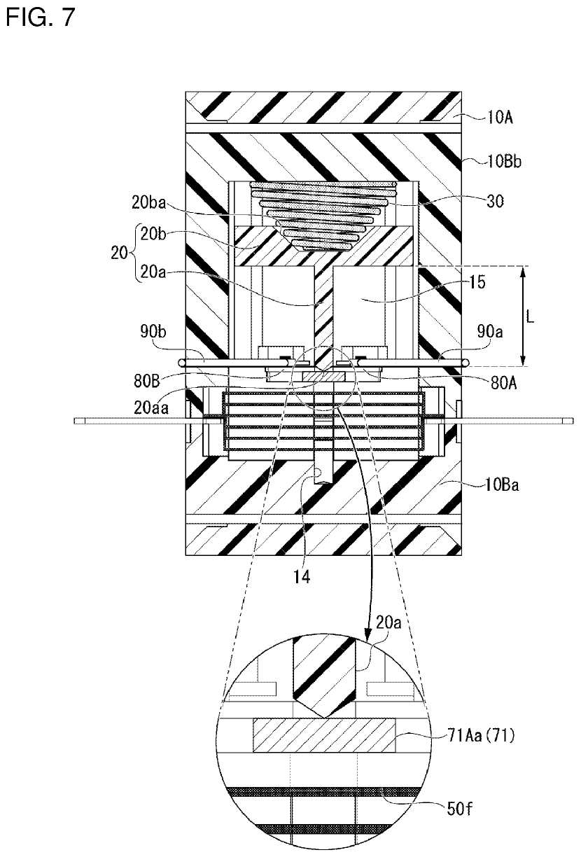

FIG. 7 illustrates a protective element having a locking member 71, which is a modified example of the locking member 70. FIG. 7 also illustrates an enlarged view of the vicinity of the locking member 71.

The locking member 71 has only a support portion 71Aa that is mounted on and supported by a groove formed in the second insulating member 60B, and is configured not having a projecting portion that contacts the fusible conductor sheet 50f.

Because the locking member 71 does not have a portion contacting the fusible conductor sheet 50f, it is not softened even if an overcurrent exceeding the rated current flows through the fusible conductor sheet, and is softened only by the heat-generating body 80. However, when arc discharge is generated due to high voltage, the arc discharge reaches the locking member 71 and fuses the locking member 71, and the protruding portion 20a shields the fusible conductor sheets 50a to 50f on the first terminal 91 side and the second terminal 92 side at the fusion portions thereof.

The material of the locking members 70 and 71 can be the same as that of the fusible conductor sheet, but in order to quickly soften due to energization of the heat-generating body 80, it is preferable that the stacked body contains a low melting point metal layer and a high melting point metal layer. For example, a material having Ag at a melting point of 962° C. plated on a periphery of an alloy whose principal component is Sn at a melting point of 217° C. can be used.

### (Heat-Generating Body)

The heat-generating body 80 is mounted so as to contact the upper surface of the locking member 70. Heat is generated by carrying a current to the heat-generating body 80, and the locking member 70 is heated by the heat, softened, and melted.

Melting of the locking member 70 causes the shielding member 20, to which a pressing force is applied downward in the Z direction by the pressing means 30, to be inserted into the gaps of the fuse element stacked body 40, cutting the fusible conductor sheet 50 and shielding the fuse element stacked body 40 on the first terminal 91 side and the second terminal 92 side.

The protective element 100 is provided with two heat-generating bodies 80 (80A, 80B), but the present invention is not limited to two heat-generating bodies.

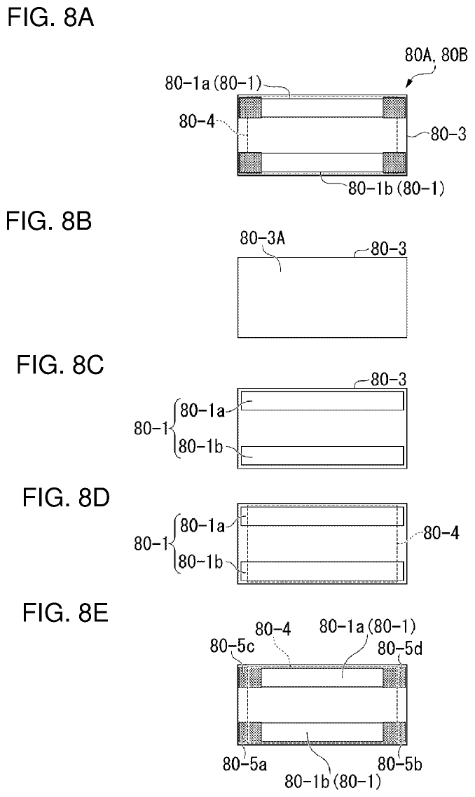

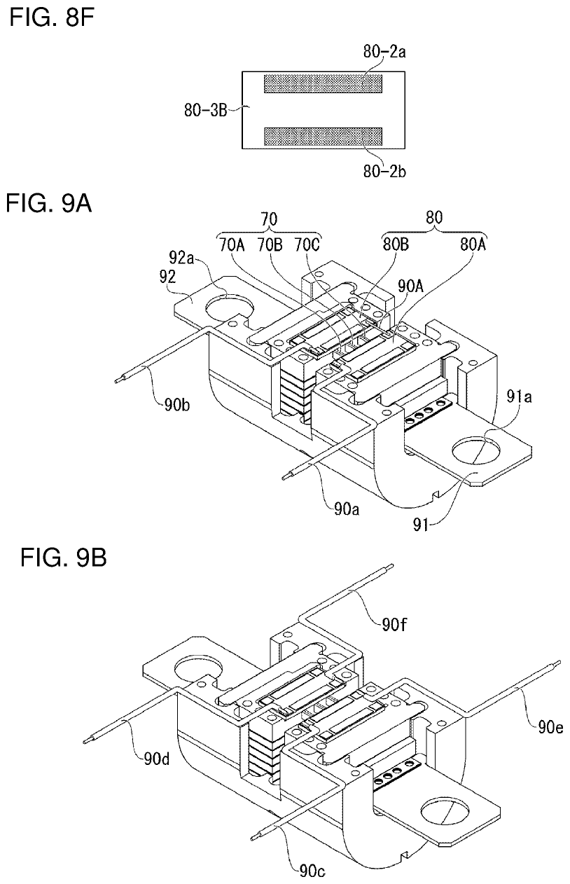

A schematic diagram of the heat-generating body 80 is illustrated in FIG. 8A to FIG. 8F. FIG. 8A is a plan view of a front surface (surface on the pressing means 30 side) of the heat-generating body 80. FIG. 8B is a plan view of an insulating substrate. FIG. 8C to FIG. 8E are respectively transparent plan views wherein three layers on the front surface side of the insulating substrate are laminated in order illustrated such that the lower layers are also visible. FIG. 8C is a plan view of a state where a resistance layer is laminated on the insulating substrate. FIG. 8D is a plan view of a state in which an insulating layer is further laminated onto FIG. 8C. FIG. 8E is a plan view of a state in which an electrode layer is further laminated onto FIG. 8D. FIG. 8F is a plan view of a rear surface (surface on the fuse element stacked body 40 side) of the heat-generating body 80.

Each of the heat-generating bodies 80A and 80B has: two resistance layers 80-1 (80-1a, 80-1b) arranged in parallel and separated from each other on a front surface 80-3A (surface on the pressing means 30 side) of an insulating substrate 80-3; an insulating layer 80-4 covering the resistance layer 80-1; a heat-generating body electrode 80-5a and a heat-generating body electrode 80-5b formed on the insulating substrate 80-3 and electrically connected to both ends of the resistance layer 80-1a; a heat-generating body electrode 80-5c and a heat-generating body electrode 80-5d electrically connected to both ends of the resistance layer 80-1b; and an electrode layer 80-2 (80-2a, 80-2b) formed on a rear surface 80-3B (surface on the fuse element stacked body 40 side) of the insulating substrate 80-3. Two resistance layers are provided for each of the heat-generating bodies 80A and 80B, and these are fail-safe designs that take into account the possibility of being mounted rotated 180 degrees, and two are not essential.

The resistance layer 80-1 is made up of a conductive material which generates heat when energized, for example, Nichrome, W, Mo, Ru, or a material containing these. The resistance layer 80-1 is formed by mixing an alloy of these, or a composition or compound powder with a resin binder or the like, forming a paste, then pattern forming this paste on the insulating substrate 80-3 using a screen printing technique, and firing, or the like. The insulating substrate 80-3 is, for example, an insulating substrate such as alumina, glass ceramic, mullite, zirconia, or the like. The insulating layer 80-4 is provided to protect the resistance layer 80-1. For example, an insulating material such as a ceramic or glass can be used as the material of the insulating layer 80-4. The insulating layer 80-4 can be formed by a method of coating and firing a paste of an insulating material.

The heat-generating body electrodes 80-5a to d on the front surface of each of the heat-generating bodies 80A and 80B and the electrode layers 80-2a and b on the rear surface are electrically insulated by the insulating substrate 80-3.

The heat-generating bodies 80A and 80B are not limited to those illustrated in FIGS. 8A to 8F, and a known heat-generating body may be used.

When a need arises to cut off a current carrying path due to, for example, an abnormality occurring in an external circuit serving as the current carrying path of the protective element 100, the heat-generating bodies 80A and 80B are energized and heated by a current control element provided on the external circuit.

### (Power Supply Member)

FIG. 9A and FIG. 9B are perspective views of the protective element for describing a method for extracting a power supply member that supplies power to the heat-generating bodies 80A and 80B. FIG. 9A illustrates when the heat-generating bodies 80A and 80B are connected in series. FIG. 9B illustrates when the heat-generating bodies 80A and 80B are connected in parallel. In the present reference example, at least a portion of the power supply member is configured by an electrical wire (wiring member). However, the present invention is not limited thereto, and while not particularly illustrated, at least a portion of the power supply member may be configured by a conductive plate-shaped or rod-shaped member.

In FIG. 9A, the power supply member 90a is connected to the heat-generating body electrode 80-5c of the heat-generating body 80A (see FIG. 8E), the power supply member 90b is connected to the heat-generating body electrode 80-5a of the heat-generating body 80B (see FIG. 8E), and the power supply member 90A is connected to the heat-generating body electrode 80-5d of the heat-generating body 80A (see FIG. 8E) and the heat-generating body electrode 80-5b of heat-generating body 80B (see FIG. 8E). Moreover, the electrode layer 80-2 of the heat-generating body 80A is connected to the electrode layer 80-2 of the heat-generating body 80B through the locking members 70 (70A, 70B, 70C). In this configuration, power is supplied by the path: “the power supply member 90a—the heat-generating body electrode 80-5c of the heat-generating body 80A—the resistance layer 80-1a of the heat-generating body 80A—the heat-generating body electrode 80-5d of the heat-generating body 80A—the power supply member 90A—the heat-generating body electrode 80-5b of the heat-generating body 80B—the resistance layer 80-1b of the heat-generating body 80B—the heat-generating body electrode 80-5a of the heat-generating body 80B—the power supply member 90b” to heat the heat-generating bodies 80A and 80B. The locking members 70 (70A, 70B, 70C) are melted by this generation of heat, and the shielding member 20 is inserted into the gaps 64 and 65 of the fuse element stacked body 40. The shielding member 20 is inserted into the gaps 64 and 65 of the fuse element stacked body 40, whereby the power supply member 90A is cut, the power supply to the heat-generating bodies 80A and 80B is cut off, and the heat generation of the heat-generating bodies 80A and 80B stops.

In FIG. 9B, a power supply member 90c is connected to the heat-generating body electrode 80-5c of the heat-generating body 80A, and a power supply member 90e is connected to the heat-generating body electrode 80-5d of the heat-generating body 80A. Moreover, a power supply member 90d is connected to the heat-generating body electrode 80-5a of the heat-generating body 80B, and a power supply member 90f is connected to the heat-generating body electrode 80-5b (see FIG. 8E). In this configuration, a first path: “the power supply member 90c—the heat-generating body 80-5c of the heat-generating body 80A—the resistance layer 80-1a of the heat-generating body 80A—the heat-generating body electrode 80-5d of the heat-generating body 80A—the power supply member 90e”, and a second path: “the power supply member 90d—the heat-generating body electrode 80-5a of the heat-generating body 80B—the resistance layer 80-1b of the heat-generating body 80B—the heat-generating body electrode 80-5b of the heat-generating body 80B—the power supply member 90f” are configured in parallel. Power is supplied by the first path and the second path, heating the heat-generating bodies 80A and 80B. The locking members 70 (70A, 70B, 70C) are melted by this generation of heat, and the shielding member 20 is inserted into the gaps 64 and 65 of the fuse element stacked body 40. In this configuration, the shielding member 20 is inserted into the gaps 64 and 65 of the fuse element stacked body 40, whereby the power supply to the heat-generating bodies 80A and 80B is not cut off and the heat generation of the heat-generating bodies 80A and 80B continues. Therefore, the heat generation of the heat-generating bodies 80A and 80B of the protective element 100 after cutting off can be stopped by appropriately stopping energization of current control elements by separate system control (a timer or the like).

### (First Terminal and Second Terminal)

One end portion of the first terminal 91 is connected to the first end portion 51 of the fusible conductor sheets 50a to 50f, and the other end portion is exposed to the outside of the insulating case 10. Moreover, one end portion of the second terminal 92 is connected to the second end portion 52 of the fusible conductor sheets 50a to 50f, and the other end portion is exposed to the outside of the insulating case 10.

The first terminal 91 and the second terminal 92 may be substantially the same shape or may have different shapes. The thickness of the first terminal 91 and the second terminal 92 is not particularly limited, but may be within a range of, for example, 0.3 mm or more and 1.0 mm or less. The thickness of the first terminal 91 and the thickness of the second terminal 92 may be the same or may be different.

The first terminal 91 is provided with an external terminal hole 91a. Moreover, the second terminal 92 is provided with an external terminal hole 92a. One of the external terminal hole 91a or the external terminal hole 92a is used for connecting to the power source side, and the other is used for connecting to the load side. Alternatively, the external terminal hole 91a and the external terminal hole 92a may be used to be connected to the internal current carrying path of the load. The external terminal hole 91a and the external terminal hole 92a can be formed into a through-hole that is substantially circular in plan view.

For example, a terminal made up of copper, brass, nickel, or the like can be used as the first terminal 91 and the second terminal 92. As materials for the first terminal 91 and the second terminal 92, it is preferable to use brass from the perspective of strengthening rigidity, and it is preferable to use copper from the perspective of reducing electrical resistance. The first terminal 91 and the second terminal 92 may be made up of the same material or may be made up of different materials.

### (Manufacturing Method of Protective Element)

The protective element 100 of the present reference example may be manufactured as follows.

First, the fuse element stacked body 40, first terminal 91, the second terminal 92 positioned by a jig are prepared. Then, the first end portion 51 of each of the fusible conductor sheets 50a to 50f of the fuse element stacked body 40 and the first terminal 91 are connected by soldering.

Moreover, the second end portions 52 and the second terminal 92 are connected by soldering. Known solder materials can be used for soldering, and from the perspective of resistivity, melting point, and being lead-free for the environment, it is preferable to use solder materials having Sn as the principal component thereof. The connection between the first end portion 51 of the fusible conductor sheets 50a to 50f and the first terminal 91 and the connection between the second end portion 52 of the fusible conductor sheets 50a to 50f and the second terminal 92 are not limited to soldering and may use a known joining method such as joining by welding.

Next, the locking members 70A, 70B, and 70C are prepared. The locking members 70A, 70B, and 70C are respectively arranged in the groove 60Ba1 and the groove 60Ba2, the groove 60Bb1 and the groove 60Bb2, and the groove 60Bec1 and the groove 60Bc2 of the second insulating member 60B illustrated in FIG. 3. Furthermore, a jig of the same shape as the second insulating member 60B may be used.

Next, the heat-generating bodies 80A and 80B illustrated in FIG. 8A and FIG. 8B, and solder paste are prepared. Then, after applying an appropriate amount of solder paste to the connecting sites of the locking members 70A, 70B, and 70C and the heat-generating bodies 80A and 80B, the heat-generating bodies 80A and 80B are arranged in predetermined positions of the second insulating member 60B as illustrated in FIG. 9A. The rear sides of the heat-generating bodies 80A and 80B are mounted on the locking members 70A, 70B, and 70C. The locking members 70A, 70B, and 70C and the heat-generating bodies 80A and 80B are connected by soldering by heating in an oven, a reflow furnace, or the like.

Next, the power supply members 90a, 90b, and 90A are prepared. The power supply member 90a is arranged on the power supply member mounting surface 12, and the power supply member 90a is connected by soldering to the heat-generating body electrode 80-5c of the heat-generating body 80A. Moreover, the power supply member 90b is arranged on the power supply member mounting surface 12, and the power supply member 90b is connected by soldering to the heat-generating body electrode 80-5a of the heat-generating body 80B. Moreover, the power supply member 90A is connected by soldering to the heat-generating body electrode 80-5d of the heat-generating body 80A and the heat-generating body electrode 80-5b of the heat-generating body 80B. The power supply members 90a, 90b, and 90A and the heat-generating bodies 80A and 80B may be connected by joining by welding, and a known joining method can be used.

Next, the second holding member 10Bb, the shielding member 20, and the pressing means 30 are prepared. Then, the pressing means 30 are arranged in the recessed portion 20ba of the shielding member 20 and housed in the second holding member 10Bb.

Next, while fitting the locking members 70A, 70B, and 70C into the grooves provided in the leading edge 20aa of the shielding member 20 and compressing the pressing means 30, the holding member 10B is formed by engaging four protrusions (not illustrated) formed in corresponding locations of the second holding member 10Bb with recessed portions 17, two of which are formed in the first end portion 10Baa and the second end portion 10Bab of the first holding member 10Ba respectively.

Next, the cover 10A is prepared. Then, the holding member 10B is inserted into the housing portion 22 of the cover 10A. Next, an adhesive is injected into a terminal adhesive injection port 16 of the holding member 10B to fill in the gap between the terminal mounting surface 111 and the first terminal 91 and the second terminal 92. Moreover, an adhesive is injected into the inclined surface 21 on the elliptical side surface of the cover 10A which is a case adhesive injection port to adhere the cover 10A and the holding member 10B. For example, an adhesive containing a thermosetting resin can be used as the adhesive. Thus, the insulating case 10 is formed having the inside of the cover 10A sealed.

The protective element 100 of the present reference example is obtained by the above steps.

In the protective element 100 of the present reference example, when an overcurrent exceeding the rated current flows through the fuse element 50 (a plurality of the fusible conductor sheets 50a to 50f), the fuse element 50 is thermally fused to cut off the current path. Other than the above, it is possible to carry a current to the heat-generating body 80 to melt the locking members 70 suppressing movement of the shielding member 20, moving the shielding member 20 by the pressing means 30 to physically cut the fuse element 50 and cut off the current path.

In the protective element 100 of the present reference example, because the movement of the shielding member 20 to which a pressing force is applied by the pressing means 30 is suppressed by the locking members 70, a cutting pressing force is not applied by the pressing means 30 and the shielding member 20 to the fuse element 50 (the plurality of fusible conductor sheets 50a to 50f) other than when the current path is cut off. Therefore, deterioration of the fuse element 50 over time is suppressed, and when there is no need to cut off the current path, disconnection stemming from the state wherein a pressing force is applied when the temperature of the fuse element 50 rises can be prevented.

In the protective element 100 of the present reference example, the fuse element stacked body 40 includes a plurality of the fusible conductor sheets 50a to 50f arranged in parallel in the thickness direction, and each of the fusible conductor sheets 50a to 50f is insulated by being proximal to or in contact with (adhered to) the first insulating members 60Aa to 60Af and the second insulating member 60B arranged therebetween. Therefore, the current value flowing through each of the fusible conductor sheets 50a to 50f lessens and the space surrounding the fusible conductor sheets 50a to 50f becomes extremely narrow, making the scale of arc discharge generated by fusion more likely to be low. That is, when the fusion space is narrow, the gas in the space is reduced, the amount of “plasma generated by ionization of the gas in the space”, which is the path through which the current flows during arc discharge, is also reduced, and arc discharge is more easily extinguished early. Therefore, according to the protective element 100 of the present reference example, the size of the insulating case 10 can be made smaller and lighter.

In the protective element 100 of the present reference example, when the first insulating member 60Aa is arranged between the fusible conductor sheet 50a arranged on the lowermost of the fusible conductor sheets 50a to 50f and the first holding member 10Ba of the insulating case 10, and the second insulating member 60B is arranged between the fusible conductor sheet 50f arranged on the uppermost of the fusible conductor sheets 50a to 50f and the second holding member 10Bb of the insulating case 10, the fusible conductor sheets 50a and 50f do not directly contact with the first holding member 10Ba and the second holding member 10Bb. Thus, a carbide that would be a conduction path is less likely to be formed on the inner surfaces of the insulating case 10 due to arc discharge, and thus leak current is less likely to occur even if the size of the insulating case 10 is reduced.

In the protective element 100 of the present reference example, when the first insulating members 60Aa to 60Af and the second insulating member 60B are separated at a position opposing the fusion portion 53 of the first end portion 51 and the second end portion 52 of the fusible conductor sheets 50a to 50f, continuous adhesion of melted scattered material on the surfaces of the first insulating members 60Aa to 60Af and the second insulating member 60B can be suppressed when the fusible conductor sheets 50a to 50f are fused at the fusion portion 53. Therefore, arc discharge caused by fusion of the fusible conductor sheets 50a to 50f can be extinguished early.

In the protective element 100 of the present reference example, at least one among the first insulating members 60Aa to 60Af, the second insulating members 60B, the shielding member 20, the cover 10A of the insulating case 10, and the holding member 10B is formed of a material having a tracking resistance index CTI of 500 V or more. Thus, a carbide that would be a conduction path is less likely to be formed on the surfaces of these components due to arc discharge, and thus leak current is even less likely to occur even if the size of the insulating case 10 is reduced.

In the protective element 100 of the present reference example, at least one among the first insulating members 60Aa to 60Af, the second insulating members 60B, the shielding member 20, the cover 10A of the insulating case 10, and the holding member 10B is formed of a polyamide-based resin or a fluorine-based resin. A polyamide-based resin or a fluorine-based resin has excellent insulating properties and tracking resistance, and therefore, the protective element 100 can be more easily be reduced in both size and weight.

In the protective element 100 of the present reference example, each of the fusible conductor sheets 50a to 50f is a stacked body containing a low melting point metal layer and a high melting point metal layer and when the low melting point metal layer contains Sn and the high melting point metal layer contains Ag or Cu, the high melting point metal is dissolved by Sn as the low melting point metal layer melts. Therefore, the fusing temperature of the fusible conductor sheets 50a to 50f is reduced. Furthermore, because Ag and Cu have higher physical strength than Sn, the physical strength of the fusible conductor sheets 50a to 50f, which are obtained by laminating a high melting point metal layer on a low melting point metal layer, becomes higher than the physical strength of the low melting point metal layer alone. Additionally, Ag and Cu have lower electrical resistivity than Sn, and the electrical resistance value of the fusible conductor sheets 50a to 50f, which are obtained by laminating a high melting point metal layer on a low melting point metal layer, becomes lower than the electrical resistance value of the low melting point metal layer alone. That is, the fuse element can handle a larger current.

In the protective element 100 of the present reference example, when each of the fusible conductor sheets 50a to 50f is a stacked body having two or more high melting point metal layers and one or more low-melting-point metal layers, wherein the low melting point metal layers are arranged between the high melting point metal layers, the strength of the fusible conductor sheets 50a to 50f increases due to the high melting point metal layers on the outer side. In particular, when connecting the first end portion 51 of the fusible conductor sheets 50a to 50f and the first terminal 91 as well as the second end portion 52 and the second terminal 92 by soldering, deformation of the fusible conductor sheets 50a to 50f due to heating during soldering occurs less readily.

In the protective element 100 of the present reference example, when each of the fusible conductor sheets 50a to 50f is a single layer containing silver or copper, the electrical resistivity is likely to be lower than when these are a stacked body having high melting point metal layers and low melting point metal layers. Therefore, the thickness of the fusible conductor sheets 50a to 50f made up of a single layer containing silver or copper can be reduced while having the same area and the same electrical resistance as the fusible conductor sheets 50a to 50f made up of a stacked body having high melting point metal layers and a low melting point metal layer. When the thickness of the fusible conductor sheets 50a to 50f is thin, the amount of melted and scattered material when the fusible conductor sheets 50a to 50f are fused decreases in proportion to the thickness, and the insulation resistance after cutting off increases.

In the protective element 100 of the present reference example, each of the fusible conductor sheets 50a to 50f has the through-hole 54 provided on the fusion portion 53 and has a fusion portion configured so a cross-sectional area of the fusion portion 53 in the current carrying direction is smaller than a cross-sectional area of the first end portion 51 and the second end portion 52 in the current carrying direction. Therefore, the region where fusion occurs when a current exceeding a rated value flows in a current path is stabilized. Note that although the through-hole 54 is provided in the fusion portion 53 in the protective element 100 of the present reference example, the method for reducing the cross-sectional area of the fusion portion 53 is not particularly limited. For example, the cross-sectional area of the fusion portion 53 may be reduced by cutting out both end portions of the fusion portion 53 in a concave shape or by partially reducing the thickness.

### Modified Example

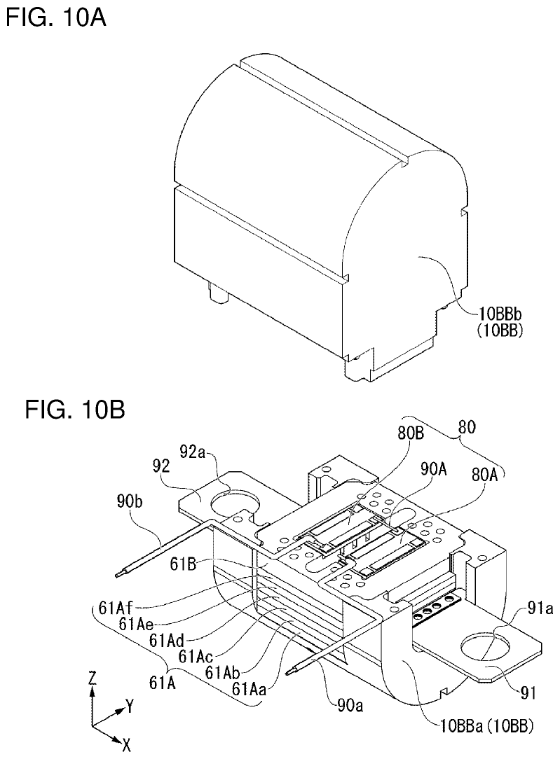

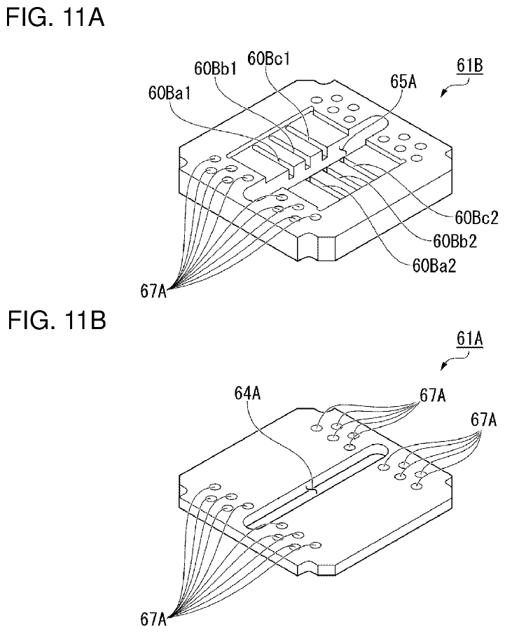

FIG. 10A and FIG. 10B are schematic diagrams of a modified example of the first reference example. FIG. 10A is a perspective view of a holding member 10BB that is a modified example of the holding member 10B. FIG. 10B is a perspective view of a configuration where a first insulating member 61A and a second insulating member 61B, which are modified examples of the first insulating member 60A and the second insulating member 60B, have an opening through which the protruding portion 20a of the shielding member 20 can move (pass through). FIG. 11A illustrates a schematic perspective view of the second insulating member, and FIG. 11B illustrates a schematic perspective view of the first insulating member. Note that because the six first insulating members have the same shape, the first insulating member illustrated in FIG. 11B illustrates the common configuration thereof.

Note that the fuse element stacked body in this modified example has a similar configuration as that illustrated in FIG. 4A to FIG. 4C other than the first insulating member. Therefore, in the description below, members that are the same as the members illustrated in FIG. 4A to FIG. 4C are described using the same reference numerals.

Each of the first insulating members 61Aa to 61Af illustrated in FIG. 10B to FIG. 11B has a first opening 64A, and the second insulating member 61B has a second opening 65A. Moreover, the length of the first opening 64A and the second opening 65A in the Y direction is greater than the length of the fusible conductor sheets 50a to 50f and the protruding portion 20a of the shielding member 20 in the Y direction. Thus, after the fusible conductor sheets 50a to 50f are cut off, the protruding portion 20a is inserted into the first opening 64A and the second opening 65A and the fusion portion of the fusible conductor sheets 50a to 50f are reliably shielded.

Each of the first insulating members 61Aa to 61Af and the second insulating member 61B respectively include, on both end sides in the Y direction, a ventilation hole 67A for efficiently releasing an increase in pressure, which accompanies arc discharge generated during cutoff of the fuse element, to a pressing means housing space of the insulating case. In the examples illustrated in the figures, each of the first insulating members 61Aa to 61Af and the second insulating member 61B are respectively both end sides in the Y direction, and have five respective ventilation holes 67A interposing the first opening 64A or the second opening 65A on the left and right, but the number thereof is not limited. The increasing pressure generated by the arc discharge passes through the ventilation hole 67A and is efficiently released to a space that houses the pressing means 30 of the insulating case 10 via gaps (not illustrated) of four corners provided between the pressing means support portion 20b and the second holding member 10BBb. Furthermore, as a result, the shielding action of the shielding member 20 is carried out smoothly and breakdown of the first insulating members 61Aa to 61Af and the second insulating member 61B is prevented.

The first opening 64A and the second opening 65A are positioned facing the fusion portion 53 arranged between the first end portion 51 and the second end portion 52 of the fusible conductor sheets 50a to 50f.

The materials of the first insulating members 61Aa to 61Af and the second insulating member 61B are preferably the same as the materials of the first insulating members 60Aa to 60Af and the second insulating member 60B, and a similar type of material can be used.

The holding members 10BB (second holding member 10BBb arranged on the upper side in the Z direction and first holding member 10BBa arranged on the lower side in the Z direction) illustrated in FIG. 10A and FIG. 10B are shaped to correspond to the modified examples of the first insulating member and the second insulating member.

### (Protective Element (Second Reference Example))

FIG. 12A to FIG. 15 are schematic diagrams illustrating a protective element according to a second reference example. In relation to the protective element according to the second reference example, the main difference from the protective element according to the first reference example is that as a mechanism for cutting off the current path, there is no an active cutoff mechanism using a heat-generating body, and there is only an overcurrent cutoff mechanism to cut off the current path by fusing the fusible conductor sheet when an overcurrent that exceeds the rated current flows through the fusible conductor sheet. Specifically, in relation to the protective element according to the second reference example, the main difference from the protective element according to the first reference example is that there is no heat-generating body and no power supply member.

In the drawings below, components that are the same as or substantially the same as those in the protective element according to the first reference example will be given the same reference numerals and descriptions thereof will be omitted.

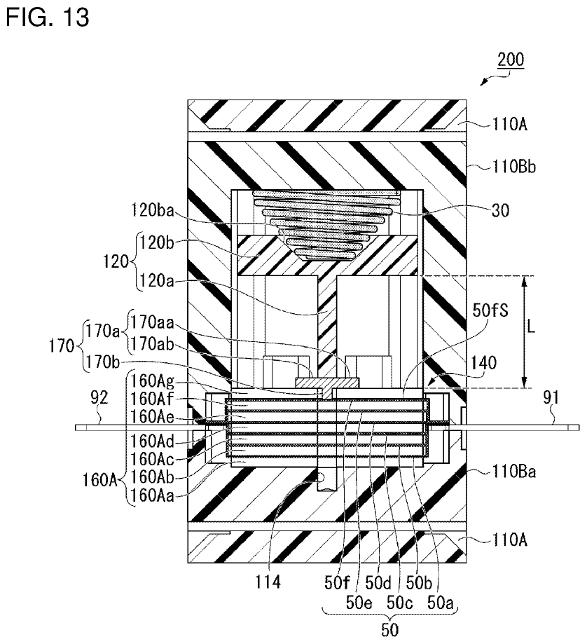

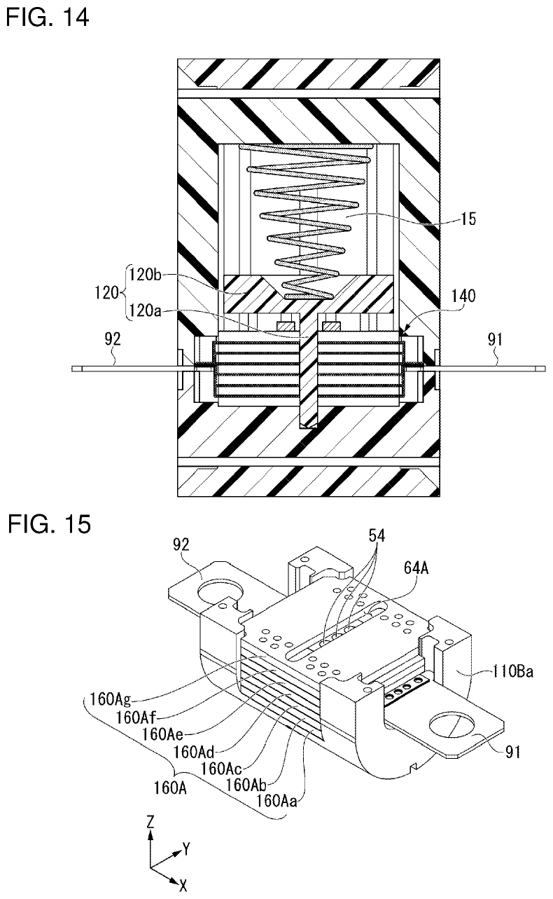

FIG. 12A is a diagram corresponding to FIG. 2 and is a partial perspective view schematically illustrated for viewing the interior of the protective element. FIG. 12B is a perspective view of the shielding member. FIG. 13 is a cross-sectional view of the protective element according to the second reference example, corresponding to FIG. 5. FIG. 14 is a cross-sectional view corresponding to FIG. 6, and is a cross-sectional view of a protective element in a state wherein a shielding member has cut the fuse element and is all the way down. FIG. 15 is a perspective view schematically illustrating a state wherein the fuse element stacked body, the first terminal, and the second terminal are disposed on the first holding member.

The protective element 200 illustrated in FIG. 12A to FIG. 15 has an insulating case 11, a fuse element stacked body 140, a first insulating member 160A, a shielding member 120, the pressing means 30, and a locking member 170. Note that in the protective element 200 of the present reference example, the current carrying direction means the direction in which electricity flows during use (X direction), and the cross-sectional area of the current carrying direction means the area of the surface (Y—Z surface) in the direction orthogonal to the current carrying direction.

### (Insulating Case)

The insulating case 11 is a substantial elongated cylindrical shape (a cross section of the Y—Z surface is an ellipse at any position in the X direction). The insulating case 11 is made up of a cover 110A and a holding member 110B.

Because the protective element 200 does not have a heat-generating body and a power supply member, accordingly, the fact that the cover 110A and the holding member 110B do not have a portion for a heat-generating body or a portion for a power supply member is a difference compared to the cover 10A and the holding member 10B.

The holding member 110B is made up of a first holding member 110Ba arranged on the lower side in the Z direction and a second holding member 110Bb arranged on the upper side in the Z direction.

The external shape of the cover 110A and the holding member 110B is small and has a substantially oblong cylindrical shape so as to withstand internal rises in pressure due to arc discharge and suppresses the amount of material used, but the exterior shape is not limited to a substantially oblong cylindrical shape and can take any shape such as a rectangular parallelepiped as long as no breakdown occurs due to arc discharge according to the rated voltage, rated current, and cutoff capacity of the protective element.

An internal pressure buffer space 15 (see FIG. 14) is formed inside the holding member 110B. The internal pressure buffer space 15 acts to suppress rapid rises in internal pressure in the protective element 200 by gas generated by arc discharge caused when the fuse element stacked body 140 is fused.

Materials similar to those of the cover 10A and the holding member 10B can be used as materials for the cover 110A and the holding member 110B.

### (Fuse Element Stacked Body)

The fuse element stacked body 140 has a plurality of the fusible conductor sheet 50 arranged in parallel in the thickness direction, and a plurality of the first insulating member 160A (160Aa to 160Ag), which is arranged between each of the plurality of fusible conductor sheets 50 and on an outer side of the fusible conductor sheets 50 arranged on the lowermost and uppermost of the plurality of fusible conductor sheets 50, in a state proximal to or in contact with the fusible conductor, and in which a first opening is formed. The plurality of fusible conductor sheets are collectively referred to as a fuse element 50. The fuse element stacked body 140 is made up of a fuse element and a first insulating member.

The plurality of fusible conductor sheets 50 has the same configuration as that illustrated in FIG. 4A to FIG. 4C, and a description of the characteristics described above will therefore be omitted. Furthermore, the plurality of first insulating members 160A (160Aa to 160Ag) are all members having the same configuration, have the same configuration as the first insulating member 61A illustrated in FIG. 10B, and a description of the characteristics described above will therefore be omitted.

The protective element 200 illustrated in FIG. 12A to FIG. 15 differs in that a first insulating member is provided in a location corresponding to the second insulating member 60B provided by the protection element 100. The protective element 200 may also be provided with an insulating member having a configuration different from that of the first insulating member, instead of the first insulating member arranged on the uppermost part.

Here, in the protective element 100, the second insulating member 60B is different from the first insulating member 60A in that a location is provided where the heat-generating body 80 is arranged, and the like. However, the first insulating member 60A can be replaced by a similar configuration, and in this case, there is no difference in configuration between the second insulating member 60B and the first insulating member 60A. In such a case, the protective element 100 and the fuse element stacked body 40 are made up of a fuse element and the first insulating member.

The fuse element stacked body 140 has six fusible conductor sheets 50a, 50b, 50c, 50d, 50e, and 50f arranged in parallel in the thickness direction (Z direction). First insulating members 160Ab, 160Ac, 160Ad, 160Ae, and 160Af are arranged between each of the fusible conductor sheets 50a to 50f. The first insulating members 160Ab to 160Af are arranged proximal to or in contact with each of the fusible conductor sheets 50a to 50f. When arranged in proximity, the distance between the first insulating members 160Ab to 160Af and the fusible conductor sheets 50a to 50f is preferably 0.5 mm or less, and more preferably 0.2 mm or less.

Moreover, the first insulating member 160Aa is arranged on an outer side of the fusible conductor sheet 50a arranged on the lowermost of the fusible conductor sheets 50a to 50f. Additionally, the first insulating member 160Ag is arranged on an outer side of the fusible conductor sheet 50f arranged on the uppermost of the fusible conductor sheets 50a to 50f. The width (length in the Y direction) of the fusible conductor sheets 50a to 50f is narrower than the width of the first insulating members 160Aa to 160Ag.

The fuse element stacked body 140 is an example wherein there are six fusible conductor sheets, but the present invention is not limited to six, and it is sufficient as long as there is a plurality.

Moreover, in each of the fusible conductor sheets 50a to 50f, the fusion portion 53, which is configured to readily be fused, is readily cut by a protruding portion 120a of the shielding member 120.

The thickness of the fusible conductor sheets 50a to 50f is a thickness that is fused by an overcurrent. The specific thickness depends on the material or number (number of sheets) of the fusible conductor sheets 50a to 50f and a pressing force (stress) of the pressing means 30, however, for example, in the case that the fusible conductor sheets 50a to 50f are a copper foil, a range can be set to 0.01 mm to 0.1 mm as a standard.

Moreover, in the case that the fusible conductor sheets 50a to 50f are a foil having Ag plated on a periphery of an alloy whose principal component is Sn, a range can be set to 0.1 mm to 1.0 mm as a standard.

Each of the first insulating members 160Aa to 160Ag has a first opening 64A through which the protruding portion 120a of the shielding member 120 can move (pass) to the central portion in the X direction.

Each of the first insulating members 160Aa to 160Ag include a ventilation hole 67A for efficiently releasing an increase in pressure, which accompanies arc discharge generated during cutoff of the fuse element, to a pressing means housing space of the insulating case. In the examples illustrated in the figures, the first insulating members 160Aa to 160Ag have five respective ventilation holes 67A interposing the first opening 64A on both end sides in the Y direction on the left and right, but the number thereof is not limited.

The increasing pressure generated by the arc discharge passes through the ventilation hole 67A and is efficiently released to a space that houses the pressing means 30 of the insulating case 11 via gaps (not illustrated) of four corners provided between the pressing means support portion 120b and the second holding member 110Bb. Furthermore, as a result, the shielding action of the shielding member 120 is carried out smoothly and breakdown of the first insulating members 160Aa to 160Ag is prevented.

The first opening 64A is positioned facing the fusion portion 53 arranged between the first end portion 51 and the second end portion 52 of the fusible conductor sheets 50a to 50f.

### (Shielding Member)

The shielding member 120 includes the protruding portion 120a, which faces the fuse element stacked body 140 side, and the pressing means support portion 120b, which includes a recessed portion 120ba that houses and supports a lower portion of the pressing means 30. An interposing groove 120aA for interposing the locking member 170 is provided on the leading edge of the protruding portion 120a. The shielding member 120 has three interposing grooves 120aA, but the present invention is not limited to this number.

Downward movement of the shielding member 120 is suppressed by the locking member 170 in a state wherein the pressing force of the pressing means 30 is applied downward. Because a projecting portion 170b of the locking member 170 is in contact with the fusible conductor sheet 50f, when an overcurrent that exceeds the rated current flows through the fusible conductor sheet, the locking member 170 transfers heat, the temperature thereof rises, and softening occurs at a temperature at or above the softening temperature. Moreover, when a large overcurrent flows and the fusible conductor sheet 50f instantly fuses, generated arc discharge also flows to the locking member 170, and the locking member 170 softens at a temperature at or above the softening temperature. The softened locking member 170 is easily physically cut by the protruding portion 120a of the shielding member 120 pressed by the pressing force of the pressing means 30.

When the locking member 170 is cut and the suppressing of downward movement by the locking member 170 is released, the shielding member 120 moves downward and physically cuts the fusible conductor sheets 50a to 50f.

The shielding member 120 has a leading edge 120aa of the protruding portion 120a that is pointed, formed to readily cut through the fusible conductor sheets 50a to 50f.

FIG. 14 illustrates a cross-sectional view of the protective element in a state wherein the shielding member 120 has moved through the first opening 64A of the fuse element stacked body 140, cut through the fusible conductor sheets 50a, 50b, 50c, 50d, 50e, and 50f using the protruding portion 120a, and the shielding member 120 is all the way down.

The shielding member 120 lowers through the first opening 64A of the fuse element stacked body 140 and cuts through the fusible conductor sheets 50f, 50e, 50d, 50c, 50b, and 50a in order using the protruding portion 120a of the shielding member 120. As a result, the cut surfaces are shielded and insulated by the protruding portion 120a, and the current carrying path through each of the fusible conductor sheets is physically and reliably cut off. Thus, arc discharge is rapidly eliminated (extinguished).

Moreover, when the shielding member 120 moves through the first opening 64A of the fuse element stacked body 140 and is all the way down, the pressing means support portion 120b of the shielding member 120 presses the fuse element stacked body 140 from the first insulating member 160Ag, and the fusible conductor sheets and the first insulating members 160Aa to 160Ag adhere to each other. Therefore, a space where arc discharge can continue therebetween is eliminated, and arc discharge is reliably eliminated.

The thickness (length in the X direction) of the protruding portion 120a is smaller than the width of the first opening 64A of the first insulating members 160Aa to 160Ag in the X direction. According to this configuration, the protruding portion 120a can move downward in the Z direction through the first opening 64A.

For example, when the fusible conductor sheets 50a to 50f are a copper foil, the difference between the thickness of the protruding portion 120a and the width of the first opening 64A in the X direction can be made to be, for example, 0.05 to 1.0 mm, and it preferably made to be 0.2 to 0.4 mm. When 0.05 mm or greater, the movement of the protruding portion 120a becomes smooth when the cut minimum thickness is 0.01 mm even if the end portion of the fusible conductor sheets 50a to 50f enters the gap between the first insulating members 160Aa to 160Ag and the protruding portion 120a, and the arc discharge is eliminated more quickly and reliably. This is because the protruding portion 120a does not easily catch when the difference described above is 0.05 mm or more. Moreover, when the difference is 1.0 mm or less, the first opening 64A functions as a guide for moving the protruding portion 120a. Therefore, a positional shift of the protruding portion 120a while moving during fusion of the fusible conductor sheets 50a to 50f is prevented, and arc discharge is more quickly and reliably eliminated. When the fusible conductor sheets 50a to 50f are a foil having Ag plated on a periphery of an alloy whose principal component is Sn, the difference between the thickness of the protruding portion 120a and the width of the first opening 64A in the X direction can be set to 0.2 to 2.5 mm, for example, and is preferably set to 0.22 to 2.2 mm.

The width (length in the Y direction) of the protruding portion 120a is wider than the width of the fusible conductor sheets 50a to 50f of the fuse element stacked body 140. According to this configuration, the protruding portion 120a can cut each of the fusible conductor sheets 50a to 50f.

The length L of the protruding portion 120a in the Z direction has a length such that the leading edge 120aa of the protruding portion 120a can reach below the first insulating member 160Aa arranged lowermost of the first insulating members 160Aa to 160Ag in the Z direction when the protruding portion is all the way down in the Z direction. When below the first insulating member 160Aa arranged lowermost, the protruding portion 120a is inserted into an insertion hole 114 formed on an inner bottom surface of the holding member 110Ba.

According to this configuration, the protruding portion 120a can cut each of the fusible conductor sheets 50a to 50f.

### (Pressing Means)

The pressing means 30 is housed in the recessed portion 120ba of the shielding member 120 while the shielding member 120 is pressed downward in the Z direction.

For the pressing means 30, the same means can be used as that provided in the protective element 100.

### (Locking Member)

For the configuration (shape and material) of the locking member 170, the same configuration can be used as that of the locking member 70. The protective element 200 is provided with three locking members 170, but the present invention is not limited to three locking members.

The locking members 170 are held while inserted into the interposing groove 120aA provided on the leading edge 120aa of the protruding portion 120a of the shielding member 120.

The locking members 170 have a T-shape and have a horizontally extending portion (support portion) 170a, made up of a first arm portion 170aa and a second arm portion 170ab, and a vertically extending portion (projecting portion) 170b extending downward from the central portion of the laterally extending portion 170a.

In the protective element 200, the horizontally extending portion 170a is supported on the shielding member-side surface 160AgS, the first arm portion 170aa and the second arm portion 170ab respectively interposing the first opening 64A of the first insulating member 160Ag, and the lower end of the vertically extending portion 170b is supported on the shielding member-side surface 50fS of the fusible conductor sheet 50f. In the examples illustrated in the figures, the shielding member-side surface 160AgS of the first insulating member 160Ag does not have a groove where the locking members 170 are mounted, but may have a groove where the locking members 170 are mounted.

When the vertically extending portion 170b is supported on the shielding member-side surface 50fS of the fusible conductor sheet 50f, when an overcurrent that exceeds the rated current flows through the fusible conductor sheet 50f, the locking members 170 contacting the fusible conductor sheet 50f transfer heat, the temperature thereof rises, and softening occurs at a temperature at or above the softening temperature.

In the protective element 200, both portions of the horizontally extending portion 170a and the vertically extending portion 170b are supported, but one of either of the portions may be supported. However, it is preferable that the vertically extending portion 170b is supported in contact with the shielding member-side surface 50fS of the fusible conductor sheet 50f so as to be softened when an overcurrent exceeding the rated current flows through the fusible conductor sheet 50f. When the vertically extending portion 170b is not in contact with the shielding member-side surface 50fS of the fusible conductor sheet 50f, it is preferable to be proximal to the shielding member-side surface 50fS.

All three locking members 170 have the same shape, but different shapes may be included.

When the temperature of the locking members 170 is at or above the softening temperature, the locking members soften enough to deform due to external forces.

The softened locking member 170 is easily physically cut by the protruding portion 120a of the shielding member 120 pressed by the pressing force of the pressing means 30. When the locking members 170 are cut, the protruding portion 120a of the shielding member 120 is inserted downward in the Z direction into the first opening 64A.

When the protruding portion 120a is inserted downward into in the Z direction into the first opening 64A, the protruding portion 120a protrudes on until reaching the lowest position while cutting the fusible conductor sheets. Thus, the protruding portion 120a shields the fusible conductor sheets 50a to 50f on the first terminal 91 side and the second terminal 92 side at the fusion portions 53 thereof. Thus, arc discharge generated when the fusible conductor sheets 50a to 50f are cut can be quickly and reliably eliminated.

Among the locking members 170, the vertically extending portion 170b is in contact with the fusible conductor sheet 50f. Thus, when an overcurrent that exceeds the rated current flows through the fusible conductor sheet, the locking members 170 in contact with the fusible conductor sheet 50f transfer heat, the temperature thereof rises, and softening occurs at a temperature at or above the softening temperature.

Moreover, when a large overcurrent flows and the fusible conductor sheet 50f instantly fuses, generated arc discharge also flows to the locking member 170, and the locking member 170 softens at a temperature at or above the softening temperature.

The softened locking member 170 is easily physically cut by the protruding portion 120a of the shielding member 120 pressed by the pressing force of the pressing means 30. When the locking members 170 are cut, the protruding portion 120a of the shielding member 120 is inserted downward in the Z direction into the first opening 64A.

In this case, an overcurrent that exceeds the rated current flows, the fusible conductor sheet is thermally fused, and the protruding portion 120a is inserted as-is downward in the Z direction into the first opening 64A. At this time, the protruding portion 120a shields the fusible conductor sheets 50a to 50f on the first terminal 91 side and the second terminal 92 side at the fusion portions thereof. Thus, arc discharge generated when the fusible conductor sheets 50a to 50f are cut can be quickly and reliably eliminated.

Even if the fusible conductor sheets are not yet thermally fused, when the protruding portion 120a is inserted downward in the Z direction into the first opening 64A, the protruding portion 120a protrudes on until reaching the lowest position while cutting the fusible conductor sheets. Thus, the protruding portion 120a shields the fusible conductor sheets 50a to 50f on the first terminal 91 side and the second terminal 92 side at the fusion portions thereof. Thus, arc discharge generated when the fusible conductor sheets 50a to 50f are cut off can be quickly and reliably eliminated.

The protective element 200 according to the second reference example, other than not having a heat-generating body or power supply member, has many members that are the same or similar to the protective element 100 according to the first reference example, so description of a manufacturing method thereof is omitted.

In the protective element 200 of the present reference example, when an overcurrent exceeding the rated current flows through the fuse element 50 (plurality of the fusible conductor sheets 50a to 50f), the fuse element 50 is thermally fused to cut off the current path.

In the protective element 200 of the present reference example, because the movement of the shielding member 120 to which a pressing force is applied by the pressing means 30 is suppressed by the locking members 170, a cutting pressing force is not applied by the pressing means 30 and the shielding member 120 to the fuse element 50 (the plurality of fusible conductor sheets 50a to 50f) other than when the current path is cut off. Therefore, deterioration of the fuse element 50 over time is suppressed, and when there is no need to cut off the current path, disconnection stemming from the state wherein a pressing force is applied when the temperature of the fuse element 50 rises can be prevented.

In the protective element 200 of the present reference example, the fuse element stacked body 140 includes a plurality of the fusible conductor sheets 50a to 50f arranged in parallel in the thickness direction, and each of the fusible conductor sheets 50a to 50f is insulated by being proximal to or in contact with (adhered to) the first insulating members 160Ab to 160Af arranged therebetween and the first insulating members 160Aa to 160Ag arranged outside of the fusible conductor sheets 50a and 50f. Therefore, the current value flowing through each of the fusible conductor sheets 50a to 50f lessens and the space surrounding the fusible conductor sheets 50a to 50f becomes extremely narrow, making the scale of arc discharge generated by fusion more likely to be low. Therefore, according to the protective element 200 of the present reference example, the size of the insulating case 11 can be made smaller and lighter.

In the protective element 200 of the present reference example, when the first insulating member 160Aa is arranged between the fusible conductor sheet 50a arranged on the lowermost of the fusible conductor sheets 50a to 50f and the first holding member 110Ba of the insulating case 11, and the first insulating member 160Ag is arranged between the fusible conductor sheet 50f arranged on the uppermost of the fusible conductor sheets 50a to 50f and the second holding member 110Bb of the insulating case 11, the fusible conductor sheets 50a and 50f do not directly contact with the first holding member 110Ba and the second holding member 110Bb. Thus, a carbide that would be a conduction path is less likely to be formed on the inner surfaces of the insulating case 11 due to arc discharge, and thus leak current is less likely to occur even if the size of the insulating case 11 is reduced.

In the protective element 200 of the present reference example, the first insulating members 160Aa to 160Ag have an opening at a position opposing the fusion portions 53 of the first end portion 51 and the second end portion 52 of the fusible conductor sheets 50a to 50f. Thus, when the fusible conductor sheets 50a to 50f are fused at the fusion portion 53, continuous adhesion of melted scattered material on the surfaces of the first insulating members 160Aa to 160Ag can be suppressed. Therefore, arc discharge caused by fusion of the fusible conductor sheets 50a to 50f can be extinguished early.

In the protective element 200 of the present reference example, at least one among the first insulating members 160Aa to 160Ag, the shielding member 120, the cover 110A of the insulating case 11, and the holding member 110B is formed of a material having a tracking resistance index CTI of 500 V or more. Thus, a carbide that would be a conduction path is less likely to be formed on the surfaces of these components due to arc discharge, and thus leak current is even less likely to occur even if the size of the insulating case 11 is reduced.

In the protective element 200 of the present reference example, at least one among the first insulating members 160Aa to 160Ag, the shielding member 120, the cover 110A of the insulating case 11, and the holding member 110B is formed of a polyamide-based resin or a fluorine-based resin. A polyamide-based resin or a fluorine-based resin has excellent insulating properties and tracking resistance, and therefore, the protective element 200 can be more easily be reduced in both size and weight.

In the protective element 200 of the present reference example, each of the fusible conductor sheets 50a to 50f is a stacked body containing a low melting point metal layer and a high melting point metal layer and when the low melting point metal layer contains Sn and the high melting point metal layer contains Ag or Cu, the high melting point metal is dissolved by Sn as the low melting point metal layer melts. Therefore, the fusing temperature of the fusible conductor sheets 50a to 50f is reduced. Furthermore, because Ag and Cu have higher physical strength than Sn, the physical strength of the fusible conductor sheets 50a to 50f, which are obtained by laminating a high melting point metal layer on a low melting point metal layer, becomes higher than the physical strength of the low melting point metal layer alone. Additionally, Ag and Cu have lower electrical resistivity than Sn, and the electrical resistance value of the fusible conductor sheets 50a to 50f, which are obtained by laminating a high melting point metal layer on a low melting point metal layer, becomes lower than the electrical resistance value of the low melting point metal layer alone. That is, the fuse element can handle a larger current.

In the protective element 200 of the present reference example, when each of the fusible conductor sheets 50a to 50f is a stacked body having two or more high melting point metal layers and one or more low melting point metal layers, wherein the low melting point metal layers are arranged between the high melting point metal layers, the strength of the fusible conductor sheets 50a to 50f increases due to the high melting point metal layers on the outer side. In particular, when connecting the first end portion 51 of the fusible conductor sheets 50a to 50f and the first terminal 91 as well as the second end portion 52 and the second terminal 92 by soldering, deformation of the fusible conductor sheets 50a to 50f due to heating during soldering occurs less readily.

In the protective element 200 of the present reference example, when each of the fusible conductor sheets 50a to 50f is a single layer containing silver or copper, the electrical resistivity is likely to be lower than when these are a stacked body having a high melting point metal layer and a low melting point metal layer. Therefore, the thickness of the fusible conductor sheets 50a to 50f made up of a single layer containing silver or copper can be reduced while having the same area and the same electrical resistance as the fusible conductor sheets 50a to 50f made up of a stacked body having high melting point metal layers and a low melting point metal layer. When the thickness of the fusible conductor sheets 50a to 50f is thin, the amount of melted and scattered material when the fusible conductor sheets 50a to 50f are fused decreases in proportion to the thickness, and the insulation resistance after cutting off increases.

In the protective element 200 of the present reference example, each of the fusible conductor sheets 50a to 50f has the through-hole 54 provided on the fusion portion 53 and has a fusion portion configured so a cross-sectional area of the fusion portion 53 in the current carrying direction is smaller than a cross-sectional area of the first end portion 51 and the second end portion 52 in the current carrying direction. Therefore, the region where fusion occurs when a current exceeding a rated value flows in a current path is stabilized. Note that although the through-hole 54 is provided in the fusion portion 53 in the protective element 200 of the present reference example, the method for reducing the cross-sectional area of the fusion portion 53 is not particularly limited. For example, the cross-sectional area of the fusion portion 53 may be reduced by cutting out both end portions of the fusion portion 53 in a concave shape or by partially reducing the thickness.

### (Protective Element (Embodiment))

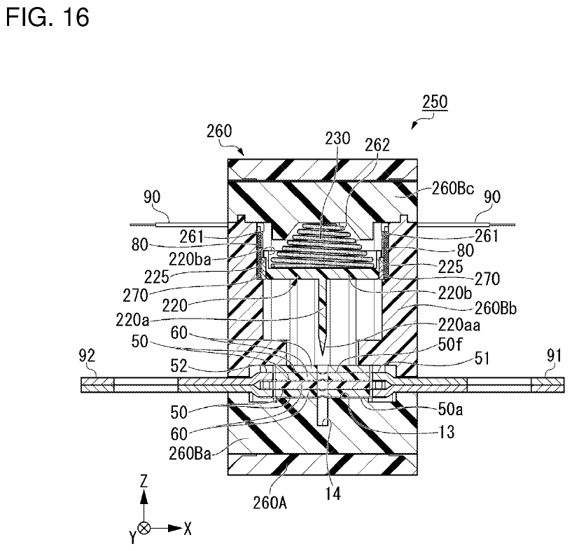

A protective element 250 according to an embodiment of the present invention will be described with reference to FIG. 16 to FIG. 19. In the protective element 250 of the embodiment, configurations mainly including the arrangement of a locking member 270 and a heat-generating body 80 and the like differs from the first and second reference examples described above. Note that in each drawing of the present embodiment, constituent members the same as or substantially the same as those of the first and second reference examples may have description thereof omitted for being given the same reference numerals and names.

FIG. 16 is a cross-sectional view illustrating the protective element 250 of the present embodiment, and specifically is a cross-sectional view illustrating the protective element 250 as a cross-section (X—Z cross-section) perpendicular to the width direction (Y direction).

The protective element 250 has an insulating case 260, the fuse element (fusible conductor sheet) 50, the first terminal 91, the second terminal 92, an insulating member 60, a shielding member 220, pressing means 230, the heat-generating body 80, the locking member 270, and a power supply member 90.

### (Insulating Case)

The insulating case 260 has at least two (three in the present embodiment) holding members 260Ba, 260Bb, and 260Bc arranged by being stacked in the vertical direction (Z direction), and a tube-shaped cover 260A that houses these holding members 260Ba, 260Bb, and 260Bc. The cover 260A is fitted to the outer side of a plurality of the holding members 260Ba, 260Bb, and 260Bc.

At least two holding members 260Ba and 260Bb are arranged on both sides of the fuse element 50 in the vertical direction. Specifically, a first holding member 260Ba arranged at the lowest position among the three holding members 260Ba, 260Bb, and 260Bc, is arranged below the fuse element 50. Moreover, a second holding member 260Bb among the three holding members 260Ba, 260Bb, and 260Bc, is arranged above the fuse element 50. A third holding member 260Bc among the three holding members 260Ba, 260Bb, and 260Bc, is arranged at the highest position.

The first holding member 260Ba has the inner bottom surface 13 which is arranged on the upper surface of the bottom wall thereof and which faces the upper side. That is, the insulating case 260 has the inner bottom surface 13. The inner bottom surface 13 has a groove 14 extending along the opening or separation part of the insulating member 60. The groove 14 extends along the width direction (Y direction) and opens on the upper side.

The second holding member 260Bb has a heat-generating body housing recess 261. The heat-generating body housing recess 261 is arranged on an inner surface facing the inner side (center side) of the current carrying direction (X direction) among side walls of the second holding member 260Bb. Specifically, the heat-generating body housing recess 261 is positioned on the upper end portion among inner surfaces of the side walls of the second holding member 260Bb. The heat-generating body housing recess 261 is recessed further to the outer side in the current carrying direction than a portion among inner surfaces of the side walls of the second holding member 260Bb adjacent to the lower side of the heat-generating body housing recess 261.

The arrangement of the heat-generating body housing recess 261 is not limited to an inner surface facing an inner side (center side) in the current carrying direction (X direction), but, for example, may be arranged on an inner surface facing an inner side (center side) in a width direction (Y direction) orthogonal to the current carrying direction (X direction) among side walls of the second holding member 260Bb.

The heat-generating body housing recess 261 is provided in a pair on the inner surface of the side wall of the second holding member 260Bb so as to face each other in the current carrying direction. That is, the pair of heat-generating body housing recesses 261 is arranged on the end portion on the first terminal 91 side (+X side) and the end portion on the second terminal 92 side (−X side) in the current carrying direction among inner surfaces of the side walls of the second holding member 260Bb.

The heat-generating body housing recess 261 is not limited to a pair, and may be arranged having one on one side.

FIG. 18 is a cross-sectional view schematically illustrating a portion of the protective element 250 in FIG. 16, and more specifically, represents a cross-section (X—Z cross-section) perpendicular to the width direction. As illustrated in FIG. 18, the second holding member 260Bb (that is, the insulating case 260) has a second step part 263. The second step part 263 is arranged at the lower end portion of the heat-generating body housing recess 261 and faces the upper side. The second step part 263 is respectively provided (that is, a pair) on the pair of heat-generating body housing recesses 261.

When one heat-generating body housing recess 261 is arranged on one side, one second step part 263 is provided on the heat-generating body housing recess 261.

As illustrated in FIG. 16, the third holding member 260Bc has a pressing means housing recess 262. The pressing means housing recess 262 is arranged on the lower surface of the top wall of the third holding member 260Bc and is recessed on the upper side.

In FIG. 16, the pressing means 230 is a conical spring where the diameter of the upper side is smaller than the diameter of the lower side, but when the diameter of the upper side of the conical spring is larger than the diameter of the lower side or when it is a cylindrical spring, the pressing means housing recess 262 may not be present.

The insulating case 260 houses the fuse element 50, a portion of the first terminal 91, a portion of the second terminal 92, the insulating member 60, the shielding member 220, the pressing means 230, the heat-generating body 80, the locking member 270, and a portion of the power supply member 90.

### (Fuse Element)

A plurality of the fuse element 50 is provided aligned in the vertical direction (thickness direction). In the present embodiment, four fuse elements 50 are arranged in parallel in the vertical direction. The insulating member 60 is respectively arranged between the vertically adjacent fuse elements 50 and on the upper side (outer side) of the fuse element 50 (50f) positioned at the uppermost.

Moreover, the inner bottom surface 13 of the first holding member 260Ba is arranged proximal to or in contact with the lower side (outer side) of the fuse element 50 (50a) located at the lowermost. That is, the inner bottom surface 13 is arranged proximal to or in contact with the opposite side (that is, the lower side) of the shielding member 220 of the fuse element 50. More specifically, the inner bottom surface 13 is arranged proximal to or in contact with the outer side of the outermost layer (fuse element 50a) of the opposite side of the shielding member 220 of the plurality of fuse elements 50.

The fuse element 50 is a plate-shape extending in a current carrying direction. A pair of surfaces (front surface and rear surface) of the fuse element 50 face in the vertical direction. Note that the vertical direction is a direction perpendicular to the surface of the fuse element 50, and therefore may be referred to in other words as the perpendicular direction. The plurality of fuse elements 50 is laminated in parallel in the perpendicular direction.

The fuse element 50 has the first end portion 51 and the second end portion 52 facing each other. That is, in other words, the fuse element 50 has the first end portion 51 and the second end portion 52 arranged at both end portions in the current carrying direction.

### (First Terminal and Second Terminal)

One end portion of the first terminal 91 is connected to the first end portion 51 and the other end portion is exposed from the insulating case 260 to the outside. Specifically, the other end portion of the first terminal 91 projects from the insulating case 260 to the first terminal 91 side (+X side) of the current carrying direction.

Moreover, one end portion of the second terminal 92 is connected to the second end portion 52 and the other end portion is exposed from the insulating case 260 to the outside. Specifically, the other end portion of the second terminal 92 projects from the insulating case 260 to the second terminal 92 side (−X side) of the current carrying direction.

### (Insulating Member)

A plurality of the insulating member 60 is provided aligned in the vertical direction. In the present embodiment, four insulating members 60 are arranged in parallel in the vertical direction. Each insulating member 60 is arranged proximal to or in contact with each fuse element 50. An opening or a separation part extending in the width direction (Y direction) is formed in the insulating members 60.

The plurality of insulating members 60 is arranged in contact with or proximal to the outer side of and between the plurality of fuse elements 50. Specifically, the plurality of insulating members 60 includes the insulating member 60 arranged on the outer side (upper side) of the outermost layer (fuse element 50f) on the shielding member 220 side (that is, the upper side) of the plurality of fuse elements 50.

However, it is not limited to this, and while not particularly illustrated, the insulating member 60 positioned on the uppermost may be formed integrally with the second holding member 260Bb and may configure a portion of the second holding member 260Bb. In this situation, the plurality of insulating members 60 is arranged in contact or proximally between the plurality of fuse elements 50.

Each opening or separation part of the plurality of insulating members 60 overlaps each other when viewed from the perpendicular direction.

### (Shielding Member)

The shielding member 220 is arranged above the fuse element 50. The shielding member 220 can move downward while being inserted into the opening or separation part of the insulating members 60 so as to divide the fuse elements 50 by the pressing force (may also be referred to in other words as stress or biasing force) of the pressing means 230 by releasing the restriction of downward movement by the locking member 270 that will be described below.

Note that the vertical direction in which the shielding member 220 moves is also the direction in which the shielding member 220 is inserted into the opening or separation part of the insulating members 60, and therefore may be referred to in other words as the insertion direction. That is, the shielding member 220 is movable in the insertion direction.

The shielding member 220 has a protruding portion 220a and a pressing means support portion 220b.

The protruding portion 220a is a plate-shape that spreads in a plane (Y-Z plane) direction perpendicular to the current carrying direction (X direction). The upper end portion of the protruding portion 220a is connected to the pressing means support portion 220b. The pressing means support portion 220b is substantially a plate-shape that spreads in a plane (X-Y plane) direction perpendicular to the vertical direction (Z direction).

The protruding portion 220a projects downward from the pressing means support portion 220b. Specifically, the protruding portion 220a projects in the insertion direction toward the opening or separation part of the insulating members 60 and the fuse element 50.

The protruding portion 220a has a leading edge 220aa that is arranged on the lower end portion of the protruding portion 220a and extends in the width direction (Y direction). Note that the leading edge 220aa may be referred to in other words as a blade portion 220aa. In a cross-section (X—Z cross-section) perpendicular to the width direction, the leading edge 220aa forms a V-shape that protrudes downward.

The pressing means support portion 220b has a recessed portion 220ba and a first step part 225. That is, the shielding member 220 has the first step part 225. The recessed portion 220ba is recessed downward from the upper surface of the pressing means support portion 220b.

As illustrated in FIG. 18, the first step part 225 projects from the outer side surface of the pressing means support portion 220b. Specifically, in the present embodiment, the first step part 225 is respectively provided (that is, a pair) on a portion facing both outer sides in the current carrying direction (X direction) among the outer side surfaces of the pressing means support portion 220b.

The first step parts 225 face the insertion direction of the shielding member 220, and specifically faces the lower side. In the insertion direction (vertical direction), the first step parts 225 and the second step parts 263 face opposite sides from each other. When viewed from the insertion direction, the first step parts 225 and the second step parts 263 do not overlap each other.

### (Pressing Means)

As illustrated in FIG. 16, the pressing means 230 is arranged above the shielding member 220. Specifically, the pressing means 230 is arranged between the upper surface of the pressing means support portion 220b and the lower surface of the third holding member 260Bc. The pressing means 230 is a spring (biasing member) such as an elastically deformable compression coil spring, and in the present embodiment, is formed in a substantially conical shape that expands in diameter according to a downward direction.

The lower part of the pressing means 230 is arranged (housed) in the recessed portion 220ba provided on the upper surface of the pressing means support portion 220b. The upper part of the pressing means 230 is arranged (housed) in the pressing means housing recess 262 provided on the lower surface of the third holding member 260Bc.

The pressing means 230 presses the shielding member 220 in the insertion direction (downward) of the shielding member 220. Specifically, the pressing means 230 is assembled in the protective element 250 in a state of being compressed in the vertical direction and elastically deformed, and presses the pressing means support portion 220b downward by a pressing force (stress, biasing force) caused by a restoring deformation force.

### (Heat-Generating Body, Power Supply Member)

As illustrated in FIG. 16 and FIG. 18, the heat-generating body 80 is a plate-shape, and a pair of surfaces (front surface and rear surface) thereof face the current carrying direction (X direction). The heat-generating body 80 is arranged (housed) in the heat-generating body housing recess 261. The heat-generating body 80 is respectively provided (that is, a pair) on the pair of heat-generating body housing recesses 261. In the present embodiment, the heat-generating bodies 80 heat and soften the locking member 270.

When the heat-generating body housing recesses 261 are arranged on an inner surface facing an inner side (center side) of the width direction (Y direction) orthogonal to the current carrying direction (X direction) among side walls of the second holding member 260Bb, the heat-generating bodies 80 are arranged in an orientation matching the heat-generating body housing recesses 261. That is, in this situation, the pair of surfaces of the heat-generating bodies 80 face the width direction (Y direction).

When one heat-generating body housing recess 261 is arranged on one side, one heat-generating body 80 is provided on the heat-generating body housing recess 261.

The power supply member 90 passes current to the heat-generating body 80.

### (Locking Member)

The locking member 270 of the present embodiment is formed of, for example, an Ag-plated solder material of a rectangular plate shape, or the like. The locking member 270 is arranged adjacent to the heat-generating bodies 80. The locking member 270 and the heat-generating bodies 80 are arranged facing each other, and in the present embodiment, the direction in which these members face is the current carrying direction (X direction). A pair of surfaces (front surface and rear surface) of the locking member 270 face in the current carrying direction (X direction). When viewed from the width direction (Y direction), a dimension L2 in the insertion direction (Z direction) of the locking member 270 is larger than a dimension (the dimension in the direction from the heat-generating bodies 80 to the locking member 270) L1 of the locking member 270 in the current carrying direction. Note that while not particularly illustrated, in the present embodiment, the dimension in the width direction (Y direction) of the locking member 270 is larger than the dimensions L1 and L2. That is, the locking member 270 is a rectangular plate-shape having the width direction as the longitudinal direction.

When the heat-generating body housing recesses 261 are arranged on an inner surface facing an inner side (center side) of the width direction (Y direction) orthogonal to the current carrying direction (X direction) among side walls of the second holding member 260Bb, the locking member 270 is arranged in an orientation matching the heat-generating body housing recesses 261. That is, in this situation, the pair of surfaces of the locking member 270 faces in the width direction (Y direction), and the direction in which the locking member 270 and the heat-generating bodies 80 face each other is the width direction (Y direction). Moreover, in this situation, when viewed from the current carrying direction (X direction), the dimension L2 in the insertion direction (Z direction) of the locking member 270 is larger than the dimension (the dimension in the direction from the heat-generating bodies 80 to the locking member 270) L1 of the locking member 270 in the width direction (Y direction).

The locking member 270 is arranged so as to be adjacent to the pair of heat-generating bodies 80, and is provided in a pair. One among the pair of surfaces (front surface and rear surface) of each locking member 270 is arranged proximal to or in contact with the heat-generating bodies 80. The other of the pair of surfaces of the locking members 270 is arranged proximal to or in contact with the outer side surface of the pressing means support portion 220b of the shielding member 220.

When one heat-generating body housing recess 261 is arranged on one side, the locking members 270 are arranged adjacent to one heat-generating body 80.

Moreover, the pair of end surfaces facing the insertion direction (vertical direction) of the locking members 270 is interposed between the first step part 225 and the second step part 263. That is, the locking members 270 are interposed and supported in the insertion direction between the pressing means support portion 220b of the shielding member 220 and the second holding member 260Bb of the insulating case 260. Thus, the locking members 270 are interposed by and locked between the insulating case 260 and the shielding member 220 in the insertion direction of the shielding member 220. That is, the locking members 270 are locked between the insulating case 260 and the shielding member 220 and suppress the movement of the shielding member 220.

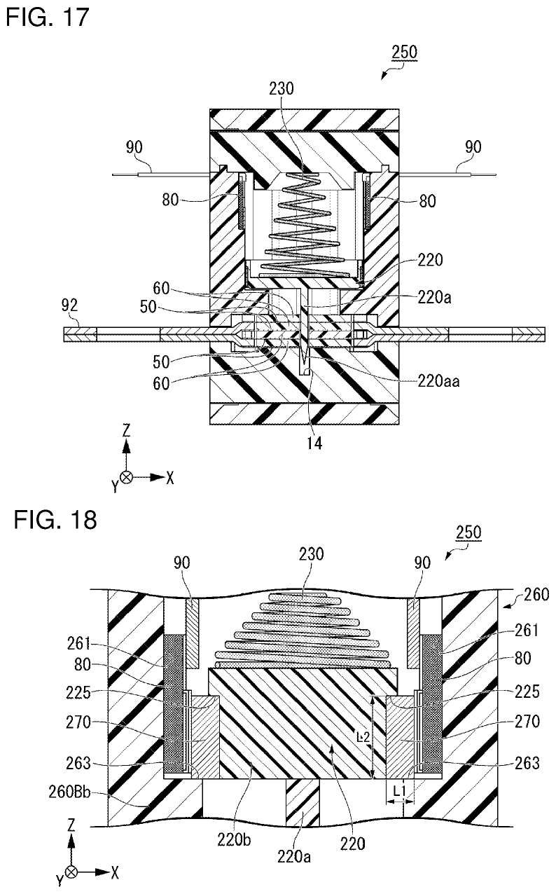

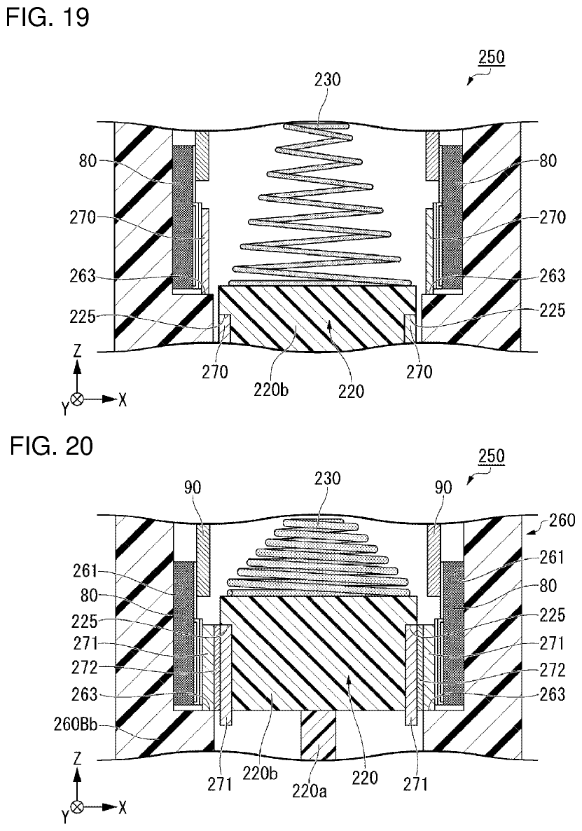

FIG. 17 and FIG. 19 are cross-sectional views (X—Z cross-sectional views) illustrating the protective element 250 or a portion thereof, and represent a state where the shielding member 220 moves downward in the insertion direction.

When power is supplied from the power supply member 90 to the heat-generating bodies 80, the heat-generating bodies 80 generate heat. When the heat-generating bodies 80 generate heat, the locking members 270 are softened by the heat. The locking members 270 softening causes the shielding member 220 to move while separating the locking members 270 by the pressing force of the pressing means 230. Specifically, as illustrated in FIG. 19 for example, the softened locking members 270 are separated on the heat-generating bodies 80 side and the shielding member 220 side. Thus, the shielding member 220 can be moved downward.

When the restriction of the downward movement of the shielding member 220 by the locking members 270 is released, the shielding member 220 moves downward by the pressing force of the pressing means 230. The shielding member 220 cuts off energization of the fuse elements 50 by moving through the opening or separation part of the insulating members 60 and cutting the fuse elements 50. Moreover, the shielding member 220 cuts the fuse elements 50, shielding each portion of the cut fuse elements 50 in the current carrying direction of the fuse elements 50.

As illustrated in FIG. 17, in the present embodiment, the leading edge 220aa of the protruding portion 220a is arranged in the groove 14 by the shielding member 220 moving downward. That is, the leading edge 220aa in the insertion direction of the shielding member 220 can be inserted into the groove 14. The shielding member 220 can move in the opening or separation part of all the insulating members 60, and in the present embodiment, can further move in the groove 14.

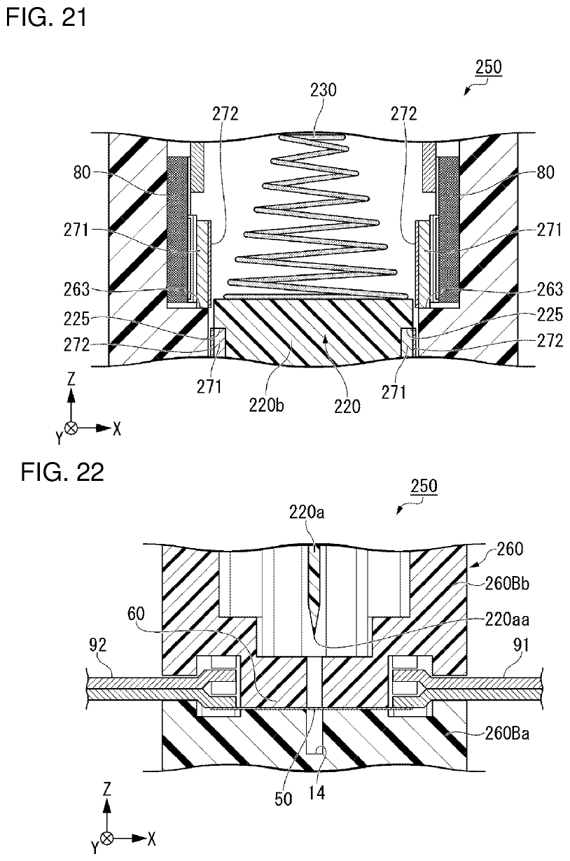

Here, FIG. 20 and FIG. 21 illustrate a cross-sectional view (X—Z cross-sectional view) partially illustrating the protective element 250 of a modified example of the present embodiment. In this modified example, instead of the locking members 270 described above, a pair of locking members 271 made up of, for example, a copper plate or the like, and a fixing member 272 made up of, for example, solder or the like, arranged between the pair of locking members 271 and fixing these locking members 271 are used. In this modified example, the heat-generating bodies 80 heat and soften the fixing members 272.

The fixing member 272 softening causes the shielding member 220 to move while separating the fixing member 272 by the pressing force of the pressing means 230.

Specifically, as illustrated in FIG. 21 for example, the softened fixing member 272 is separated into one locking member 271 side and the other locking member 271 side among the pair of locking members 271 interposing the fixing member 272. Thus, the shielding member 220 can be moved downward.

In the protective element 250 of the present embodiment, when an overcurrent exceeding the rated current flows through the fuse elements 50, the fuse elements 50 are thermally fused to cut off the current path. Other than the above, it is possible to carry a current to the heat-generating bodies 80 to soften the locking members 270 or the fixing member 272 suppressing movement of the shielding member 220, moving the shielding member 220 by the pressing force of the pressing means 230 to physically cut the fuse elements 50 and cut off the current path.

Furthermore, in the present embodiment, the fuse elements 50 and the insulating members 60 are proximal or in contact, and preferably adhered. Therefore, a space where arc discharge can continue between the fuse elements 50 and the insulating members 60 is eliminated, and arc discharge is reliably eliminated. In the present embodiment, the locking members 270 and 271 are not arranged near the fuse elements 50, are provided between the insulating case 260 and the shielding member 220, and the downward movement of the shielding member 220 is restricted by locking by these members.

Therefore, the locking members 270 and 271 can be arranged apart from members such as the fuse elements 50 and the insulating members 60, which may rise in temperature during energization (during normal use) of the protective element 250. Thus, the function of the locking members 270 and 271 being affected by a temperature increase of each member can be suppressed.

Moreover, since the pressing force of the pressing means 230 is not transmitted to the fuse elements 50 and the insulating members 60 via the locking members 270 and 271, the functions of the fuse elements 50 and the insulating members 60 are favorably maintained over a long period.

Moreover, the leading edge 220aa of the protruding portion 220a of the shielding member 220 can be arranged closer by the fuse elements 50 and the insulating members 60. Thus, the outer dimensions of the insulating case 260 in the vertical direction (insertion direction, thickness direction) can be kept small, and the protective element 250 can be reduced in size.

According to the present embodiment as above, it is possible to provide a protective element 250 wherein large-scale arc discharge does not readily occur when the fuse elements 50 fuse, the size of the insulating case 260 can be made smaller and lighter, and both overcurrent cutoff in response to a high voltage/high current and a cutoff function via a cutoff signal are accomplished.

Furthermore, in the present embodiment, the locking members 270 or the fixing member 272 is softened by heat generation of the heat-generating bodies 80, causing the shielding member 220 to move downward while separating the locking members 270 or the fixing member 272 by the pressing force of the pressing means 230. Since downward movement restriction of the shielding member 220 is stably released, energization of the fuse elements 50 can be more reliably cut off.

Furthermore, in the present embodiment, when the shielding member 220 is moved downward, the leading edge 220aa of the protruding portion 220a is inserted into the groove 14 of the inner bottom surface 13 of the insulating case 260. Thus, the fuse elements 50 proximal to in contact with the inner bottom surface 13 can be reliably cut by the shielding member 220.

Moreover, in the present embodiment, when viewed from the width direction (Y direction), the dimension L2 of the locking members 270 in the insertion direction is larger than the dimension (the dimension in the direction from the heat-generating bodies 80 to the locking members 270) L1 of the locking members 270 in the current carrying direction. Alternatively, when viewed from the current carrying direction (X direction), the dimension L2 of the locking members 270 in the insertion direction is larger than the dimension (the dimension in the direction from the heat-generating bodies 80 to the locking members 270) L1 of the locking member 270 in the width direction.

According to the above configuration, because the shearing force of the locking members 270 in the insertion direction is increased, the locking members 270 can be stably held (locked) between the insulating case 260 and the shielding member 220.

Furthermore, in the present embodiment, the pair of end surfaces facing the insertion direction of the locking members 270 and 271 is interposed by the first step parts 225 and the second step parts 263, and when viewed from the insertion direction, the first step parts 225 and the second step parts 263 do not overlap each other.

According to the configuration described above, when the locking members 270 or the fixing member 272 that fixes the locking members 271 is softened and the shielding member 220 moves downward due to the pressing force of the pressing means 230, the first step parts 225 and the second step parts 263 that held the locking members 270 and 271 reliably pass by each other in the insertion direction. Thus, the first step parts 225 and the second step parts 263 do not obstruct the downward movement of the shielding member 220, and the current of the fuse elements 50 is reliably cut off.

### Modified Example

FIG. 22 is a cross-sectional view (X—Z cross-sectional view) partially illustrating the protective element 250 of a modified example of the embodiment. In this modified example, one or both among the two holding members 260Ba and 260Bb of the insulating case 260 are formed integrally with the insulating members 60. In the illustrated example, one (holding member 260Bb) among the two holding members 260Ba and 260Bb is integrally formed with the insulating members 60. Moreover, the fuse element 50 is provided with only a single (one) layer.

In the above configuration, the insulating members 60 are integrated with the holding members 260Ba and 260Bb. Thus, the number of components can be reduced, manufacture of the protective element 250 can be made easier, and manufacturing costs can be reduced.

### Modified Example

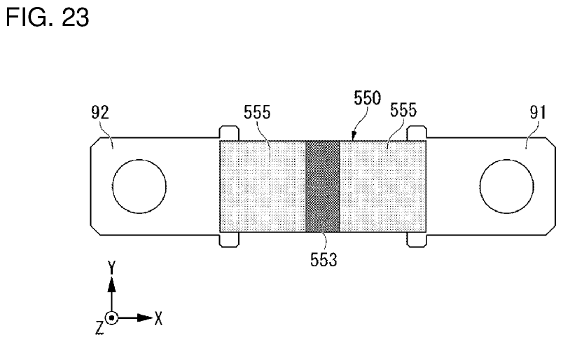

FIG. 23 is a schematic diagram of a fuse element 550 according to a modified example of the embodiment, and is a plan view corresponding to FIG. 4A.

In this modified example, the fuse element 550 has a first fusible conductor 555 and a second fusible conductor 553 having a melting point lower than that of the first fusible conductor 555. Moreover, the first fusible conductor 555 and the second fusible conductor 553 are connected in series in energization. That is, the first fusible conductor 555 and the second fusible conductor 553 are electrically connected in series, and in this modified example, are arranged aligned in the current carrying direction (X direction).

Moreover, the first fusible conductor 555 and the second fusible conductor 553 may be arranged aligned in the insertion direction (Z direction). Specifically, while not illustrated, the fuse element 550 overlaps a vicinity of the tip end of the inner side (center side) in the current carrying direction (X direction) of the two first fusible conductors 555, and a gap of this overlap may be connected by the second fusible conductor 553. That is, each tip end portion of the two first fusible conductors 555 and one second fusible conductor 553 positioned between these tip end portions are arranged so as to overlap when viewed from the insertion direction (Z direction), and the first fusible conductors 555 and the second fusible conductor 553 may be connected (electrically) in series in energization.

According to this structure, the current carrying distance of the second fusible conductor 553 having an electrical resistivity higher than that of the first fusible conductors 555 can be shortened, and an increase in the electrical resistance of the fuse element 550 can be suppressed.

Moreover, the second fusible conductor 553 is arranged between the two first fusible conductors 555.

According to the above constitution, the second fusible conductor 553 is arranged at the central portion in the current carrying direction of the fuse element 550, and the fuse element 550 can be fused from the central portion.

In this modified example, when a current exceeding the rated value flows through the current path of the fuse element 550, the second fusible conductor 553 fuses before the first fusible conductors 555, and thus, the position of the portion of the fuse element 550 where the current is cut off is stabilized. As a result, the energization of the fuse element 550 can be cut off without damage to the insulating members 60 and the insulating case 260 from the energization of 1.5 to 2 times to an explosive cutoff at 10 times or more the rated current.

Furthermore, the shielding member 220 is moved by heat generation of the heat-generating bodies 80, and the second fusible conductor 553 is cut.

According to the above configuration, the second fusible conductor 553 having a lower melting point even in the fuse element 550 is cut by downward movement of the shielding member 220. Even when time is required for fusing of the second fusible conductor 553 when an overcurrent flows, the fuse element 550 can be reliably cut by the shielding member 220.

Moreover, when the fuse element 550 has a configuration in which the tip end vicinities of two first fusible conductors 555 are overlapped and connected by the second fusible conductor 553, the first fusible conductors 555 are cut by the downward movement of the shielding member 220. In this situation, it is preferable that the cut portion of the first fusible conductors 555 has a smaller cross-sectional area than the portion other than the cut portion of the first fusible conductors 555.

The protective element of the present invention is not limited to the embodiments described above.

The present invention may combine the configurations described above in the embodiments, modified examples, reference examples, and the like, and can add, omit, replace, or otherwise change the configurations within a scope that does not deviate from the spirit of the present invention. Furthermore, the present invention is not limited by the embodiments and the like described above, and is limited only by the scope of claims.

### INDUSTRIAL APPLICABILITY

According to the protective element of the present invention, large-scale arc discharge does not readily occur when the fuse element is fused, and the size of the insulating case can be made smaller and lighter. Moreover, it is possible to provide a protective element having both an overcurrent cutoff function in response to a high voltage/high current and a cutoff function by a cutoff signal. Therefore, the present invention has industrial applicability.

### DESCRIPTION OF REFERENCE NUMERALS

10, 11, 260 . . . Insulating case
20, 120, 220 . . . Shielding member
30, 230 . . . Pressing means
50, 550 . . . Fuse element
51 . . . First end portion
52 . . . Second end portion
60, 60A, 60B, 160A . . . Insulating member
64, 65 . . . Separation part
64A, 65A . . . Opening
70, 70A, 70B, 70C, 71, 170, 270, 271 . . . Locking member
80 . . . Heat-generating body
90, 90a, 90b, 90c, 90d, 90e, 90f, 90A . . . Power supply member
91 . . . First terminal
92 . . . Second terminal
100, 200, 250 . . . Protective element
272 . . . Fixing member
555 . . . First fusible conductor
553 . . . Second fusible conductor

1: A protective element comprising:
a fuse element comprising: a first end portion; and a second end portion at an opposite end of the first end portion;
an insulating case that houses the fuse element;
a first terminal comprising: a first end connected to the first end portion of the fuse element; and a second end exposed on outside of the insulating case;
a second terminal comprising: a first end connected to the second end portion of the fuse element; and a second end exposed on outside of the insulating case;
an insulating member disposed in a state proximal to or in contact with the fuse element and having an opening or a separation part;
a shielding member movable in an insertion direction to be inserted into the opening or the separation part of the insulating member so as to divide the fuse element;
a pressing member that presses the shielding member in the insertion direction;
a locking member that is fixed between the insulting case and the shielding member, optionally using a fixing member, and suppresses movement of the shielding member;
a heat-generating body configured to heat and soften the locking member or the fixing member; and
a power supply member that carries current to the heat-generating body,
wherein the insulating case further houses the insulating member, the shielding member, the pressing member, the locking member, the heat-generating body, and a portion of the power supply member.

2: The protective element according to claim 1, wherein the heat-generating body generates heat so as to soften the locking member or the fixing member, pressing force of the pressing member causes the shielding member to move while separating the locking member or the fixing member, and the shielding member moves through the opening or the separation part of the insulating member to cut the fuse element, thereby cutting off energization of the fuse element.

3: The protective element according to claim 2, wherein the when shielding member cuts the fuse element, the shielding member shields each portion of the cut fuse element in a current carrying direction of the fuse element.

4: The protective element according to claim 1, wherein the pressing member is a spring.

5: The protective element according to claim 1, wherein at least one of the insulating member, the shielding member, and the insulating case comprises a material having a comparative tracking index CTI of 500 V or more.

6: The protective element according to claim 1, wherein at least one of the insulating member, the shielding member, and the insulating case comprises at least one resinous material selected from the group consisting of a polyamide-based resin and a fluorine-based resin.

7: The protective element according to claim 1, wherein the fuse element has a stacked body comprising a low melting point metal layer and a high melting point metal layer, the low melting point metal layer comprises tin, and the high melting point metal layer comprises silver or copper.

8: The protective element according to claim 7, wherein the stacked body comprises two or more high melting point metal layers and one or more low melting point metal layers, and has a structure in which the low melting point metal layer is disposed between the high melting point metal layers.

9: The protective element according to claim 1, wherein the fuse element is formed of a single layer comprising silver or copper.

10: The protective element according to claim 1, wherein the fuse element comprises a fusion portion between the first end portion and the second end portion, and a cross-sectional area of the fusion portion in a current carrying direction from the first end portion to the second end portion of the fuse element is less than a cross-sectional area of the first end portion and the second end portion in the current carrying direction.

11: The protective element according to claim 1, wherein the fuse element comprises a first fusible conductor and a second fusible conductor having a lower melting point than the first fusible conductor,
the first fusible conductor and the second fusible conductor being connected in series in energization.

12: The protective element according to claim 11, wherein the second fusible conductor is disposed between two first fusible conductors.

13: The protective element according to claim 11, wherein the shielding member is configured to move and cut the second fusible conductor due to heat generation of the heat-generating body.

14: The protective element according to claim 1, wherein the insulating case comprises an inner bottom surface disposed in a state proximal to or in contact with the fuse element on the opposite side of the shielding member,
the inner bottom surface has a groove extending along the opening or the separation part of the insulating member, and
a leading edge of the shielding member in the insertion direction being insertable into the groove.

15: The protective element according to claim 1, comprising a plurality of the fuse elements, each of which has a plate shape, the fuse elements laminated in parallel in a perpendicular direction relative to a surface of the fuse element, and
a plurality of the insulating members disposed in contact or proximally between the plurality of fuse elements, wherein
each of the openings or the separation parts of the plurality of insulating members overlaps each other when viewed from the perpendicular direction, and the shielding member is movable within all of the openings or the separation parts.

16: The protective element according to claim 15, wherein the plurality of insulating members comprise an insulating member disposed on the outer side of an outermost layer on the shielding member side of the plurality of fuse elements,
the insulating case has an inner bottom surface disposed in a state proximal to or in contact with the outer side of an outermost layer on the opposite side of the shielding member of the plurality of fuse elements,
the inner bottom surface has a groove extending along the opening or the separation part of the insulating member, and
the shielding member is movable within all of the openings or the separating portions and the groove.

17: The protective element according to claim 1, comprising a plurality of fuse elements, each of which has a plate shape, the fuse elements being laminated in parallel in a perpendicular direction relative to a surface of the fuse element, and
a plurality of insulating members disposed in contact or proximally between and on the outer side of the plurality of fuse elements, wherein
each of the openings or the separation parts of the plurality of insulating members overlaps each other when viewed from the perpendicular direction, and the shielding member is movable within all of the openings or the separation parts.

18: The protective element according to claim 1, wherein the fuse element has a plate shape,
the insulating case comprises at least two holding members disposed on both sides of the fuse element in a perpendicular direction relative to a surface of the fuse element,
at least one holding member being formed integrally with the insulating member.

19: The protective element according to claim 1, wherein the locking member is fixed by being interposed between the insulating case and the shielding member in the insertion direction, and
a dimension of the locking member in the insertion direction is larger than a dimension of the locking member in a direction from the heat-generating body to the locking member when viewed from a width direction orthogonal to a current carrying direction of the fuse element and the insertion direction or when viewed from the current carrying direction.

20: The protective element according to claim 1, wherein the shielding member has a first step part facing the insertion direction,
the insulating case has a second step part facing the opposite side to the first step part in the insertion direction, and
a pair of end surfaces of the locking member facing the insertion direction is interposed between the first step part and the second step part, and
when viewed from the insertion direction, the first step part and the second step part do not mutually overlap.
